(19) United States
(12) Patent Application Publication
(10) Pub. No.: US 2009/0160849 A1
(43) Pub. Date: Jun. 25, 2009

(54) INTEGRATED CIRCUIT DEVICE, ELECTRO-OPTICAL DEVICE, AND ELECTRONIC INSTRUMENT

(75) Inventors: Hiroshi KIYA, Suwa-shi (JP); Chihiro SHIN, Chino-shi (JP); Haruo KAMIJO, Shiojiri-shi (JP); Motoaki NISHIMURA, Fujimi-machi (JP); Katsuhiko MAKI, Chino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/340,025

(22) Filed: Dec. 19, 2008

(30) Foreign Application Priority Data
Dec. 20, 2007 (JP) 2007-328574

(51) Int. Cl. G09G 5/00

(52) U.S. Cl. 345/214

(57) ABSTRACT

An integrated circuit device includes first to Nth data driver blocks that are disposed along a first direction. Each of the first to Nth data driver blocks includes first to Mth sub-driver blocks. Each of the sub-driver blocks includes a D/A conversion circuit that receives image data and D/A-converts the image data, and first to Lth data line driver circuits that are disposed along the first direction in a second direction with respect to the D/A conversion circuit and share the D/A conversion circuit.

Japanese Patent Application No. 2007-328574 filed on Dec. 20, 2007, is hereby incorporated by reference in its entirety.

### BACKGROUND

The present invention relates to an integrated circuit device, an electro-optical device, an electronic instrument, and the like.

As an electro-optical panel used for electronic instruments (e.g., portable telephone, television, and projector (projection-type display device)), a simple matrix type liquid crystal panel, an active matrix type liquid crystal panel that utilizes a switch element (e.g., thin film transistor), and the like have been known. An electro-optical panel that utilizes a light-emitting element such as an electroluminescence (EL) element has also attracted attention.

In recent years, the number of data lines (source lines) of an electro-optical panel has increased along with an increase in the screen size and the number of pixels of an electro-optical panel. On the other hand, an increase in accuracy of a voltage applied to each data line has been desired. A reduction in power consumption and chip size of a data driver (source driver) that drives data lines of an electro-optical panel has also been desired along with a demand for a reduction in power consumption and weight and size of electronic instruments provided with an electro-optical panel.

For example, JP-A-2005-175811 and JP-A-2005-175812 disclose a configuration that enables a rail-to-rail operation of an output circuit of a data driver that drives a data line while supplying a voltage to the data line with high accuracy.

According to the technologies disclosed in JP-A-2005-175811 and JP-A-2005-175812, the rail-to-rail operation is implemented by controlling the drive capability by providing an auxiliary circuit in each output circuit. Therefore, the circuit scale of the data driver increases due to the addition of the auxiliary circuit. Moreover, the transistor size must be increased in order to suppress a variation in voltage applied to the data line. As a result, the chip size increases.

JP-A-2007-243125 discloses technology that reduces the chip size by adjacently disposing a data driver block and a memory block along the long side direction of an integrated circuit device.

According to the technology disclosed in JP-A-2007-243125, a narrow chip can be implemented. However, a reduction in chip size achieved by the technology disclosed in JP-A-2007-243125 is insufficient due to an increase in the circuit area of the data driver block, an increase in the wiring area of signal lines provided from the data driver block to data signal pads, and the like.

### SUMMARY

According to one aspect of the invention, there is provided an integrated circuit device comprising:

first to Nth (N is an integer equal to or larger than two) data driver blocks that are disposed along a first direction and supply data signals to a plurality of data lines of an electro-optical device,

each of the first to Nth data driver blocks including first to Mth (M is an integer equal to or larger than two) sub-driver blocks, and

a Jth (J is an integer that satisfies 1≦J≦M) sub-driver block among the first to Mth sub-driver blocks including:

a D/A conversion circuit that receives image data and D/A-converts the image data; and

first to Lth (L is an integer equal to or larger than two) data line driver circuits that are disposed along the first direction in a second direction with respect to the D/A conversion circuit and share the D/A conversion circuit, the second direction being a direction that perpendicularly intersects the first direction.

According to another aspect of the invention, there is provided an electro-optical device comprising the above integrated circuit device.

According to another aspect of the invention, there is provided an electronic instrument comprising the above electro-optical device.

### BRIEF DESCRIPTION OF THE DRAWINGS

FIG. 1 shows a circuit configuration example of an integrated circuit device according to one embodiment of the invention.

FIGS. 2A and 2B show configuration examples of a power supply circuit and a grayscale voltage generation circuit.

FIG. 3 shows a layout example of an integrated circuit device according to one embodiment of the invention.

FIG. 4 shows a detailed layout example of a data driver block.

FIG. 5 is a view illustrative of a signal repeater circuit and a bias repeater circuit.

FIG. 6 shows a configuration example of a bias repeater circuit.

FIG. 7 shows a detailed layout example of a sub-driver block.

FIG. 8 shows a further detailed layout example of a sub-driver block.

FIGS. 9A to 9C are views illustrative of a flip-around sample-hold circuit.

FIG. 10 shows another layout example of an integrated circuit device.

FIGS. 11A and 11B are views illustrative of integrated circuit devices according to comparative examples.

FIG. 12 shows a detailed layout example of an integrated circuit device.

FIG. 13 is a view illustrative of data transfer between a data driver block and a memory block.

FIG. 14 shows a configuration example of a pre-latch circuit, a post-latch circuit, and a data driver block.

FIG. 15 shows a signal waveform example illustrative of the operation of circuits shown in FIG. 14.

FIG. 16 shows another configuration example of a pre-latch circuit, a post-latch circuit, and a data driver block.

FIG. 17 shows a configuration example of a data driver.

FIG. 18 shows a second configuration example of a data driver.

FIG. 19 shows a signal waveform example illustrative of the operation of a data driver.

FIG. 20 shows a modification of a data driver.

FIG. 21 is a view illustrative of the operations of a D/A conversion circuit, a switch circuit, and a grayscale generation amplifier.

FIGS. 22A and 22B are views illustrative of a flip-around sample-hold circuit.

FIGS. 23A and 23B show a configuration example of a grayscale generation amplifier using a flip-around sample-hold circuit.

FIG. 24 is a view illustrative of the circuit operation of a grayscale generation amplifier.

FIGS. 25A to 25C are views illustrative of a switch control method according to one embodiment of the invention.

FIGS. 26A and 26B show configuration examples of an electronic instrument.

### DESCRIPTION OF EXEMPLARY EMBODIMENTS

Several aspects of the invention may provide an integrated circuit device, an electro-optical device, and an electronic instrument that can be reduced in circuit scale and enable an efficient layout.

According to one embodiment of the invention, there is provided an integrated circuit device comprising:

first to Nth (N is an integer equal to or larger than two) data driver blocks that are disposed along a first direction and supply data signals to a plurality of data lines of an electro-optical device,

each of the first to Nth data driver blocks including first to Mth (M is an integer equal to or larger than two) sub-driver blocks, and

a Jth (J is an integer that satisfies 1≦J≦M) sub-driver block among the first to Mth sub-driver blocks including:

a D/A conversion circuit that receives image data and D/A-converts the image data; and

first to Lth (L is an integer equal to or larger than two) data line driver circuits that are disposed along the first direction in a second direction with respect to the D/A conversion circuit and share the D/A conversion circuit, the second direction being a direction that perpendicularly intersects the first direction.

According to this embodiment, since the D/A conversion circuit is shared by the first to Lth data line driver circuits, the area occupied by the D/A conversion circuit can be reduced so that the size of the integrated circuit device can be reduced. According to this embodiment since the first to Lth data line driver circuits are disposed along the first direction in the second direction with respect to the D/A conversion circuit, an output signal line of the D/A conversion circuit can be connected to each data line driver circuit along a short path. Therefore, the wiring area of the output signal line can be reduced. Moreover, since each data driver block and the data driver can be formed by merely disposing the first to Mth sub-driver blocks along the first direction, for example, an efficient layout can be implemented.

The integrated circuit device may further comprise:

a plurality of repeater circuits, each of the plurality of repeater circuits being provided between adjacent sub-driver blocks among the first to Mth sub-driver blocks.

An appropriate signal can be supplied to the sub-driver block corresponding to the repeater circuit by providing the repeater circuit.

In the integrated circuit device,

each of the plurality of repeater circuits may include a bias repeater circuit that receives a reference bias signal and supplies a bias signal generated based on the reference bias signal to the first to Lth data line driver circuits included in a corresponding sub-driver block among the first to Mth sub-driver blocks.

A change in the bias signal can be suppressed by providing the bias repeater circuit. For example, when each data line driver circuit includes an operational amplifier, the bias current of the operational amplifier can be stabilized.

In the integrated circuit device,

each of the first to Lth data line driver circuits may include:

an operational amplifier; and

at least one capacitor,

a capacitor area may be provided in the second direction with respect to an operational amplifier area, the operational amplifier being disposed in the operational amplifier area, and the at least one capacitor being formed in the capacitor area.

According to this configuration, since the capacitors included in the first to Lth data line driver circuits can be collectively disposed in the capacitor area, a highly accurate capacitor can be formed. Moreover, the layout efficiency can be improved.

In the integrated circuit device,

a plurality of repeater circuit signal lines may be provided in the capacitor area along the first direction.

According to this configuration, since the repeater circuit signal line can be provided by effectively utilizing the capacitor area, the layout efficiency can be improved.

The integrated circuit device may farther comprise:

first to Nth memory blocks that are disposed along the first direction in a fourth direction with respect to the first to Nth data driver blocks and store the image data, the fourth direction being a direction opposite to the second direction,

a Jth memory block among the first to Nth memory blocks may dot-sequentially read subpixel image data and may output the subpixel image data to a corresponding Jth data driver block among the first to Nth data driver blocks, the subpixel image data being image data corresponding to at least one subpixel; and

the Jth data driver block may receive the subpixel image data from the Jth memory block, and may output data signals corresponding to the subpixel image data.

According to this configuration, the dependence on the positional relationship between the first to Nth memory blocks and the first to Nth data driver blocks can be eliminated. Therefore, the degree of freedom relating to the layout can be increased so that the layout efficiency can be improved.

In the integrated circuit device,

the Jth memory block and the Jth data driver block may be disposed so that a center position of the Jth memory block is shifted in the first direction with respect to a center position of the Jth data driver block.

According to this configuration, other circuits, pads, and the like can be disposed in the space formed by the above-mentioned layout (i.e., the center position of the Jth memory block is shifted in the direction D1 with respect to the center position of the Jth data driver block) so that the layout efficiency can be improved.

The integrated circuit device may further comprise:

first to Nth pre-latch circuits; and

first to Nth post-latch circuits,

a Jth pre-latch circuit among the first to Nth pre-latch circuits may sequentially latch the subpixel image data output from the Jth memory block by time division; and

a Jth post-latch circuit among the first to Nth post-latch circuits may line-sequentially read and latch the subpixel image data after the Jth pre-latch circuit has latched the subpixel image data, and may output the subpixel image data to the Jth data driver block.

Since the first to Nth pre-latch circuits and the first to Nth post-latch circuits are provided, the subpixel image data output from the Jth memory block by time division can be latched and efficiently transferred to the Jth data driver block, for example.

In the integrated circuit device,

the D/A conversion circuit may receive subpixel image data as the image data, and may output grayscale voltages corresponding to the subpixel image data by time division in each of first to Lth sample periods; and

each of the first to Lth data line driver circuits may sample the grayscale voltages output from the D/A conversion circuit in each of the first to Lth sample periods.

According to this configuration, since the D/A conversion circuit can be shared by sampling the grayscale voltages using the first to Lth data line driver circuits, the layout area can be reduced.

In the integrated circuit device,

the D/A conversion circuit may output a first grayscale voltage and a second grayscale voltage corresponding to the subpixel image data by time division in each of the first to Lth sample periods; and

each of the first to Lth data line driver circuits may include a grayscale generation amplifier that samples the first grayscale voltage and the second grayscale voltage output from the D/A conversion circuit in each of the first to Lth sample periods, and generates a grayscale voltage between the first grayscale voltage and the second grayscale voltage.

According to this configuration, even if the D/A conversion circuit outputs the first grayscale voltage and the second grayscale voltage by time division, a voltage can be appropriately sampled in each of the first to Lth sample periods by utilizing the sample function of the grayscale generation amplifier. Therefore, an integrated circuit device that can supply a voltage to the data line by a small circuit configuration even when the number of grayscales increases can be provided.

In the integrated circuit device,

the grayscale generation amplifier may be configured by a flip-around sample-hold circuit.

The grayscale generation amplifier can be provided with a voltage sample-hold function, and an offset-free state can be implemented by utilizing the flip-around sample-hold circuit. Therefore, a highly accurate voltage that varies to only a small extent can be supplied to the data line.

In the integrated circuit device,

the grayscale generation amplifier may include:

an operational amplifier;

a first sampling capacitor that is provided between a first input terminal of the operational amplifier and a first input node of the grayscale generation amplifier and stores a charge corresponding to an input voltage at the first input node in a sample period; and

a second sampling capacitor that is provided between the first input terminal of the operational amplifier and a second input node of the grayscale generation amplifier and stores a charge corresponding to an input voltage at the second input node in the sample period,

the grayscale generation amplifier may output an output voltage in a hold period, the output voltage corresponding to charges stored in the first sampling capacitor and the second sampling capacitor in the sample period.

According to this configuration, the voltages input to the first input node and the second input node can be sampled into the first sampling capacitor and the second sampling capacitor in the sample period, and the output voltage corresponding to charges stored in the first sampling capacitor and the second sampling capacitor can be output in the hold period by performing the flip-around operation of the first sampling capacitor and the second sampling capacitor.

In the integrated circuit device,

the grayscale generation amplifier may include:

an operational amplifier, an analog reference power supply voltage being supplied to a second input terminal of the operational amplifier;

a first sampling switch element and a first sampling capacitor, the first sampling switch element and the first sampling capacitor being provided between a first input node of the grayscale generation amplifier and a first input terminal of the operational amplifier;

a second sampling switch element and a second sampling capacitor, the second sampling switch element and the second sampling capacitor being provided between a second input node of the grayscale generation amplifier and the first input terminal of the operational amplifier;

a feedback switch element provided between an output terminal and the first input terminal of the operational amplifier;

a first flip-around switch element provided between a first connection node and the output terminal of the operational amplifier, the first connection node being situated between the first sampling switch element and the first sampling capacitor; and

a second flip-around switch element provided between a second connection node and the output terminal of the operational amplifier, the second connection node being situated between the second sampling switch element and the second sampling capacitor.

According to this configuration, the input voltages can be sampled into the first sampling capacitor and the second sampling capacitor using the first sampling switch element, the second sampling switch element, and the feedback switch element, and the flip-around operation of the first sampling capacitor and the second sampling capacitor can be implemented using the first flip-around switch element and the second flip-around switch element.

In the integrated circuit device,

the first sampling switch element, the second sampling switch element, and the feedback switch element may be turned ON and the first flip-around switch element and the second flip-around switch element may be turned OFF in the sample period; and

the first sampling switch element, the second sampling switch element, and the feedback switch element may be turned OFF and the first flip-around switch element and the second flip-around switch element may be turned ON in a hold period.

Since the first sampling switch element, the second sampling switch element, and the feedback switch element are turned ON in the sample period, charges corresponding to the input voltage can be stored in the first sampling capacitor and the second sampling capacitor utilizing the virtual short-circuit function of the operational amplifier. Since the first flip-around switch element and the second flip-around switch element are turned ON in the hold period, an output voltage corresponding to charges stored in the first sampling capacitor and the second sampling capacitor can be output to the output node of the grayscale generation amplifier.

In the integrated circuit device,

the first sampling switch element and the second sampling switch element may be turned OFF after the feedback switch element has been turned OFF.

This minimizes an adverse effect of charge injection via the first sampling switch element, the second sampling switch element, and the like.

According to another embodiment of the invention, there is provided an electro-optical device comprising one of the above integrated circuit devices.

According to another embodiment of the invention, there is provided an electronic instrument comprising the above electro-optical device.

Preferred embodiments of the invention are described in detail below. Note that the following embodiments do not in any way limit the scope of the invention defined by the claims laid out herein. Note that all elements of the following embodiments should not necessarily be taken as essential requirements for the invention.

1. Circuit Configuration of Integrated Circuit Device

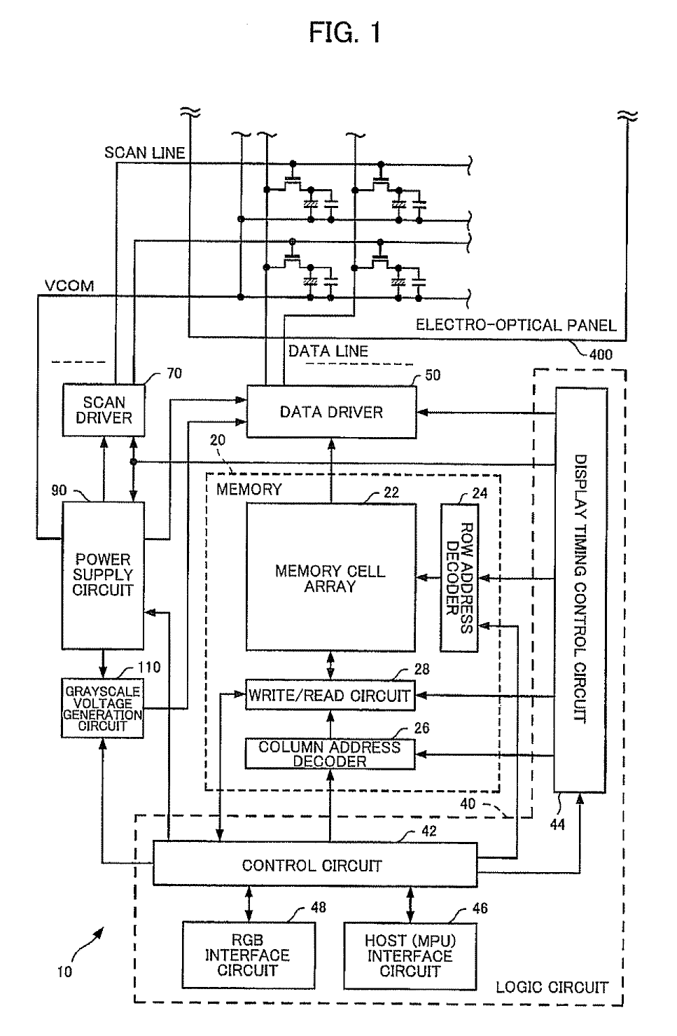

FIG. 1 shows a circuit configuration example of an integrated circuit device 10 (driver) according to one embodiment of the invention. Note that the integrated circuit device 10 according to this embodiment is not limited to the configuration shown in FIG. 1. Various modifications may be made such as omitting some of the elements (e.g., scan driver, grayscale voltage generation circuit, or logic circuit) or adding other elements.

An electro-optical panel 400 (electro-optical device) includes a plurality of data lines (e.g., source lines), a plurality of scan lines (e.g., gate lines), and a plurality of pixels specified by the data lines and the scan lines. A display operation is implemented by changing the optical properties of an electro-optical element (liquid crystal element, EL element, or the like in a narrow sense) in each pixel area. The electro-optical panel (display panel in a narrow sense) may be formed using an active matrix type panel utilizing a switch element such as a TFT or TFD, for example. The electro-optical panel may be a panel other than the active matrix type panel, or may be a panel using a light-emitting element such as an organic electroluminescence (EL) element or an inorganic EL element.

A memory 20 (display data RAM) stores image data. A memory cell array 22 includes a plurality of memory cells. The memory cell array 22 stores image data (display data) corresponding to at least one frame (one screen). A row address decoder 24 (MPU/LCD row address decoder) decodes a row address, and selects a wordline of the memory cell array 22. A column address decoder 26 (MPU column address decoder) decodes a column address, and selects a bitline of the memory cell array 22. A write/read circuit 28 (MPU write/read circuit) writes image data into the memory cell array 22, or reads image data from the memory cell array 22.

A logic circuit 40 (driver logic circuit) generates a control signal that controls a display timing, a control signal that controls a data processing timing, and the like. The logic circuit 40 may be formed by automatic placement and routing (e.g., gate array (G/A)), for example.

A control circuit 42 generates various control signals, and controls the entire device. Specifically, the control circuit 42 outputs grayscale adjustment data (gamma correction data) that adjusts grayscale characteristics (gamma characteristics) to a grayscale voltage generation circuit 110, and outputs power supply adjustment data that adjusts a power supply voltage to a power supply circuit 90. The control circuit 42 also controls a memory write/read process using the row address decoder 24, the column address decoder 26, and the write/read circuit 28.

A display timing control circuit 44 generates various control signals that control the display timing, and controls reading of image data from the memory 20 into the electro-optical panel 400. A host (MPU) interface circuit 46 implements a host interface that generates an internal pulse corresponding to each access from a host and accesses the memory 20. An RGB interface circuit 48 implements an RGB interface that writes motion picture RGB data into the memory 20 based on a dot clock signal. Note that the integrated circuit device 10 may be configured to include only one of the host interface circuit 46 and the RGB interface circuit 48.

A data driver 50 is a circuit that generates a data signal (voltage or current) supplied to the data line of the electro-optical panel 400 (electro-optical device). Specifically, the data driver 50 receives image data (grayscale data or display data) from the memory 20, and receives a plurality of (e.g., 256-stage) grayscale voltages (reference voltages) from the grayscale voltage generation circuit 110. The data driver 50 selects a voltage (data voltage) corresponding to the image data (grayscale data) from the plurality of grayscale voltages, and outputs the selected voltage to the data line of the electro-optical panel 400.

A scan driver 70 generates a scan signal that drives the scan line of the electro-optical panel 400. Specifically, the scan driver 70 sequentially shifts a signal (enable input-output signal) using a shift register provided therein, and outputs a signal obtained by converting the level of the shifted signal to each scan line of the electro-optical panel 400 as the scan signal (scan voltage). The scan driver 70 may include a scan address generation circuit and an address decoder. The scan address generation circuit may generate and output a scan address, and the address decoder may decode the scan address to generate the scan signal.

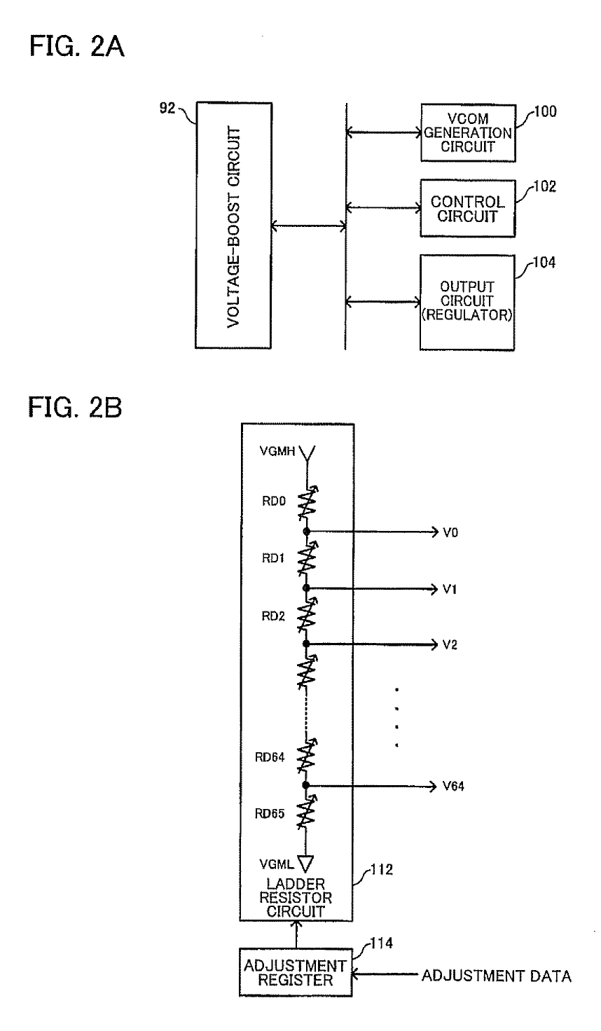

The power supply circuit 90 is a circuit that generates various power supply voltages. FIG. 2A shows a configuration example of the power supply circuit 90. A voltage booster circuit 92 is a circuit that boosts an input power supply voltage or an internal power supply voltage by a charge-pump method using a boost capacitor and a boost transistor to generate a boosted voltage. The voltage booster circuit 92 may include first to fourth voltage booster circuits and the like. A high voltage used in the scan driver 70 and the grayscale voltage generation circuit 110 can be generated by the voltage booster circuit 92. A VCOM generation circuit 100 generates and outputs a voltage VCOM supplied to a common electrode of the electro-optical panel 400. A control circuit 102 controls the power supply circuit 90, and includes various control registers and the like. An output circuit 104 (regulator circuit or power supply voltage supply circuit) adjusts the boosted voltage generated by the voltage booster circuit 92, for example, and outputs various power supply voltages.

The grayscale voltage generation circuit (gamma correction circuit) 110 is a circuit that generates the grayscale voltage. FIG. 2B shows a configuration example of the grayscale voltage generation circuit 110. A ladder resistor circuit 112 (voltage divider circuit) generates and outputs grayscale voltages V0 to V64 based on grayscale-voltage-generation power supply voltages VGMH and VGML generated by the power supply circuit 90. Specifically, the ladder resistor circuit 112 includes a plurality of resistors RD0 to RD65 connected in series between the power supply voltages VGMH and VGML, and outputs the grayscale voltages V0 to V64 to taps between the resistors RD0 to RD65. The resistors RD0 to RD65 are variable resistors. The resistances of the resistors RD0 to RD65 are set based on the grayscale adjustment data set in an adjustment register 114. Therefore, grayscale voltages having grayscale characteristics (gamma correction characteristics) optimum for the type of the electro-optical panel 400 and the like can be generated.

When performing polarity inversion drive, the grayscale voltages V0 to V64 may be caused to differ between a positive period (first period in a broad sense) and a negative period (second period in a broad sense). In this case, the grayscale voltages in the positive period and the grayscale voltages in the negative period may be generated by changing the resistances of the resistors RD0 to RD65 of the ladder resistor circuit 112 based on the grayscale adjustment data.

The grayscale characteristics may be caused to differ corresponding to R (first color component in a broad sense), G (second color component in a broad sense), and B (third color component in a broad sense). When causing the grayscale characteristics (gamma characteristics) to differ corresponding to R, G, and B, the grayscale voltage generation circuit 110 may output R grayscale voltages in an R (red) sample period of a sample-hold circuit included in the data driver 50, may output G grayscale voltages in a G (green) sample period of the sample-hold circuit, and may output B grayscale voltages in a B (blue) sample period of the sample-hold circuit. In this case, the R, G, and B grayscale voltages may be generated by changing the resistances of the resistors RD0 to RD65 of the ladder resistor circuit 112 based on the grayscale data.

The configuration of the grayscale voltage generation circuit 110 is not limited to the configuration shown in FIG. 2B. Various modifications may be made such as providing a circuit (e.g., operational amplifier) that subjects the grayscale voltages V0 to V64 to impedance conversion, providing a plurality of ladder resistor circuits corresponding to the positive period and the negative period, or providing a plurality of ladder resistor circuits corresponding to R, G, and B.

2. Layout of Integrated Circuit Device

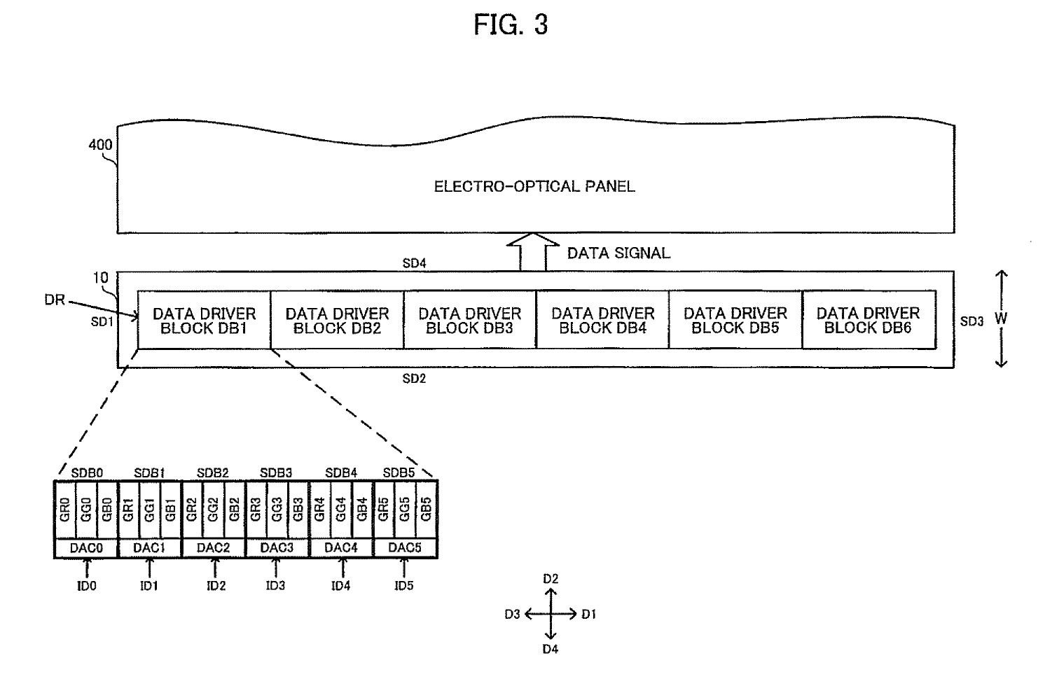

FIG. 3 shows a layout example of the integrated circuit device 10 according to this embodiment. In FIG. 3, the direction from a first side SD1 (short side) of the integrated circuit device 10 toward a third side SD3 opposite to the first side SD1 is referred to as a first direction D1, and the direction opposite to the first direction D1 is referred to as a third direction D3. The direction from a second side SD2 (long side) of the integrated circuit device 10 toward a fourth side SD4 opposite to the second side SD2 is referred to as a second direction D2, and the direction opposite to the second direction D2 is referred to as a fourth direction D4. In FIG. 3, the left side of the integrated circuit device 10 is the first side SD1, and the right side of the integrated circuit device 10 is the third side SD3. Note that the left side of the integrated circuit device 10 may be the third side SD3, and the right side of the integrated circuit device 10 may be the first side SD1.

The integrated circuit device 10 shown in FIG. 3 includes data driver blocks DB1 to DB6 (first to Nth data driver blocks in a broad sense; N is an integer equal to or larger than two) that supply data signals (data voltages or data currents) to the data lines of the electro-optical panel 400 (electro-optical device). The data driver blocks DB1 to DB6 form a data driver DR.

Each of the data driver blocks DB1 to DB6 includes sub-driver blocks SDB0 to SDB5 (first to Mth sub-driver blocks in a broad sense; M is an integer equal to or larger than two). Each of the sub-driver blocks SDB0 to SDB5 outputs data signals corresponding to at least one pixel based on image data. For example, the sub-driver block SDB0 outputs R, G, and B data signals corresponding to (supplied to) a first pixel (first data line) based on image data ID0. The sub-driver block SDB1 outputs R, G, and B data signals corresponding to (supplied to) a second pixel adjacent to the first pixel (second data line adjacent to the first data line) based on image data ID1. The above description also applies to the sub-driver blocks SDB2 to SDB5.

The number of data driver blocks and the number of sub-driver blocks included in each data driver block are not limited to six, but may be arbitrary numbers. Each sub-driver block may output data signals corresponding to two or more pixels. For example, the sub-driver block SDB0 may output data signals corresponding to (supplied to) the first and second pixels (first and second data lines). A modification in which one sub-driver block is shared by a plurality of data lines is also possible.

Each of the sub-driver blocks SDB0 to SDB5 (Jth sub-driver block among the first to Mth sub-driver blocks in a broad sense; J is an integer that satisfies 1≦J≦M) includes a D/A conversion circuit, and a plurality of data line driver circuits (subpixel driver cells or grayscale amplifiers) that share the D/A conversion circuit.

For example, the sub-driver block SDB0 includes a D/A conversion circuit DAC0 and data line driver circuits GR0, GG0, and GB0 that share the D/A conversion circuit DAC0 by time division. The data line driver circuits GR0, GG0, and GB0 are R, G, and B data line driver circuits, respectively. The data line driver circuits GR0, GG0, and GB0 output R, G, and B data signals, respectively. The sub-driver block SDB1 includes a D/A conversion circuit DAC1 and data line driver circuits GR1, GG1, and GB1 that share the D/A conversion circuit DAC1 by time division. The data line driver circuits GR1, GG0, and GB1 are R, G, and B data line driver circuits, respectively. The data line driver circuits GR1, GG1, and GB1 output R, G, and B data signals, respectively. The above description also applies to the sub-driver blocks (cells) SDB2 to SDB5.

The D/A conversion circuit DAC0 receives the image data ID0, and D/A-converts the image data ID0. For example, the D/A conversion circuit DAC0 D/A-converts the image data ID0 output from a latch circuit (not shown) provided in the preceding stage of the D/A conversion circuit DAC0. Specifically, the D/A conversion circuit DAC0 receives a plurality of grayscale voltages (reference voltages) from the grayscale voltage generation circuit 110 shown in FIG. 1, and selects a grayscale voltage corresponding to the digital image data ID0 from the plurality of grayscale voltages, and outputs the selected grayscale voltage. The above description also applies to the D/A conversion circuits DAC1 to DAC5.

The data line driver circuit GR0 buffers the R data signal (grayscale voltage or data voltage) output from the D/A conversion circuit DAC0 using an operational amplifier or the like, and outputs the R data signal to the R data line of the electro-optical panel 400 to drive the data line. The data line driver circuit GR0 buffers the G data signal output from the D/A conversion circuit DAC0 using an operational amplifier or the like, and outputs the G data signal to the G data line to drive the data line. The data line driver circuit GR0 buffers the B data signal output from the D/A conversion circuit DAC0 using an operational amplifier or the like, and outputs the B data signal to the B data line. The above description also applies to the data line driver circuits GR1 to GB1, GR2 to GB2, GR3 to GB3, GR4 to GB4, and GR5 to GB5.

More specifically, when each data line driver circuit includes a sample-hold circuit (e.g., grayscale amplifier and driver amplifier), the D/A conversion circuit DAC0 receives subpixel image data as the image data, and outputs grayscale voltages corresponding to the subpixel image data by time division in first, second, and third sample periods (first to Lth sample periods in a broad sense). The data line driver circuits GR0, GG0, and GB0 (first to Lth data line driver circuits in a broad sense) sample the grayscale voltages output from the D/A conversion circuit DAC0 in the first, second, and third sample periods (first to Lth sample periods), respectively. For example, the data line driver circuit GR0 samples and holds the grayscale voltage output in the first sample period, and drives the R data line. The data line driver circuit GG0 samples and holds the grayscale voltage output in the second sample period, and drives the G data line. The data line driver circuit GB0 samples and holds the grayscale voltage output in the third sample period, and drives the B data line. The above description also applies to the data line driver circuits GR1 to GB1, GR2 to GB2, GR3 to GB3, GR4 to GB4, and GR5 to GB5.

In this embodiment, the data line driver circuits GR0 to GB0 (first to Lth data line driver circuits) are disposed along the direction D1 in the direction D2 with respect to the D/A conversion circuit DAC0, as shown in FIG. 3. The data line driver circuits GR1 to GB1, GR2 to GB2, GR3 to GB3, GR4 to GB4, and GR5 to GB5 are disposed in the same manner as the data line driver circuits GR0 to GB0.

According to this embodiment shown in FIG. 3, since one D/A conversion circuit (e.g., DAC0) is provided corresponding to a plurality of data line driver circuits (e.g., GR0, GG0, and GB0), the area occupied by the D/A conversion circuits in the integrated circuit device 10 can be reduced so that the size (scale) of the integrated circuit device 10 can be reduced.

According to this embodiment, since the data line driver circuits are disposed along the direction D1 in the direction D2 with respect to the D/A conversion circuit, an output signal line of the D/A conversion circuit can be connected to each data line driver circuit along a short path. Moreover, an output signal line of each data line driver circuit can be connected to a data signal pad along a short path. Therefore, the wiring area of the output signal lines can be reduced so that the layout efficiency can be improved. As a result, the width W of the integrated circuit device 10 in the direction D2 can be reduced so that a narrow chip can be implemented.

According to this embodiment, each data driver block and the data driver can be formed by merely disposing a plurality of sub-driver blocks along the direction D1 so that the integrated circuit device 10 having the layout shown in FIG. 3 can be implemented. Therefore, the efficiency of the layout process and the circuit design can be improved. For example, it is possible to deal with a change in the number of pixels of the electro-optical panel 400 by merely changing the number of sub-driver blocks. Therefore, the efficiency of the layout process can be significantly improved.

3. Repeater Circuit

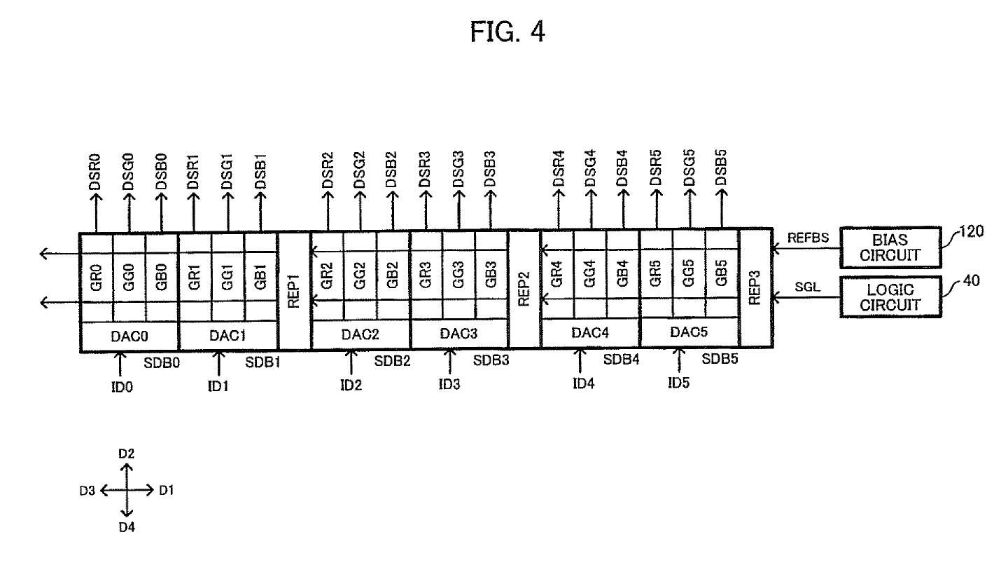

FIG. 4 shows a detailed layout example of the data driver block and the sub-driver blocks. In FIG. 4, a plurality of repeater circuits RP1, RP2, and RP3 are provided. Each of the repeater circuits RP1, RP2, and RP3 is provided between adjacent sub-driver blocks among the sub-driver blocks SDB0 to SDB5 (first to Mth sub-driver blocks). In other words, the repeater circuits are provided at intervals of a plurality of sub-driver blocks. For example, the repeater circuit REP1 is provided between the sub-driver blocks SDB1 and SDB2, the repeater circuit REP2 is provided between the sub-driver blocks SDB3 and SDB4, and the repeater circuit REP3 is provided between the sub-driver block SDB5 and the sub-driver block of the adjacent data driver block.

In FIG. 4, the sub-driver block SDB0 outputs R, G, and B data signals DSR0, DSG0, and DSB0 corresponding to one pixel based on the subpixel image data ID0. Likewise, the sub-driver block SDB1 outputs R, G, and B data signals DSR1, DSG1, and DSB1 corresponding to one pixel. The above description also applies to the sub-driver blocks SDB2 to SDB5.

The logic circuit 40 generates a control signal SGL. The operations of the data line driver circuit and the D/A conversion circuit of the sub-driver block are controlled based on the control signal SGL. For example, a switch element included in the sample-hold circuit of the data line driver circuit is ON/OFF-controlled based on the control signal SGL so that the sample timing, the hold timing, and the like are controlled. The data line driver circuit and the D/A conversion circuit may be enabled or disabled based on the control signal SGL.

Each of the repeater circuits RP1, RP2, and RP3 receives the control signal SGL, and supplies a signal obtained by buffering the control signal SGL to the corresponding sub-driver block. For example, the repeater circuit REP1 supplies a signal obtained by buffering the control signal SGL to the sub-driver blocks SDB0 and SDB1. Likewise, the repeater circuit REP2 supplies a signal obtained by buffering the control signal SGL to the sub-driver blocks SDB2 and SDB3, and the repeater circuit REP3 supplies a signal obtained by buffering the control signal SGL to the sub-driver blocks SDB4 and SDB5. Note that the control signal SGL may be directly supplied to each repeater circuit, or may be buffered by each repeater circuit and supplied to the repeater circuit in the subsequent stage.

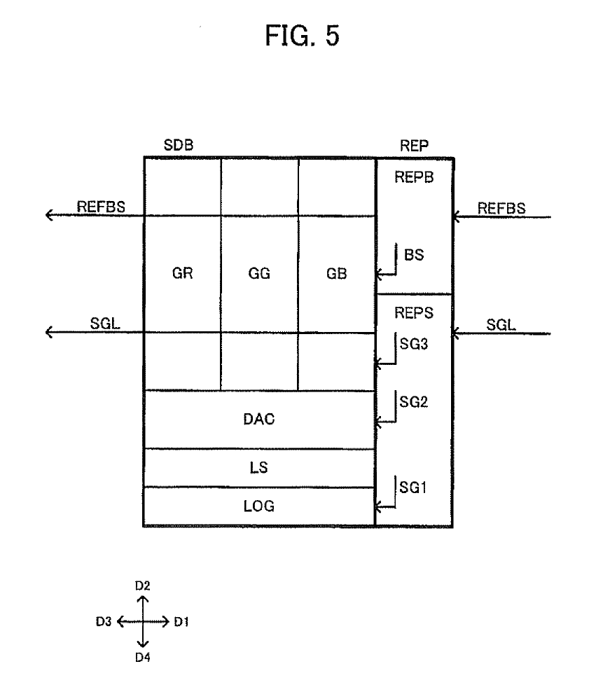

In FIG. 5, each of the repeater circuits REP (REP1, REP2, and REP3) includes a signal repeater circuit REPS. The signal repeater circuit REPS supplies signals SG1, SG2, and SG3 obtained by buffering the control signal SGL using a buffer circuit to circuits of the corresponding sub-driver block SDB. Specifically, the signal SG1 is supplied to a sub-driver block logic circuit LOG, the signal SG2 is supplied to the D/A conversion circuit DAC, and the signal SG3 is supplied to the data line driver circuits GR, GG, and GB. The signal SG1 is a signal obtained by buffering a logic circuit control signal included in the control signal SGL, the signal SG2 is a signal obtained by buffering a D/A conversion circuit control signal included in the control signal SGL, and the signal SG3 is a signal obtained by buffering a data line driver circuit control signal included in the control signal SGL. A level shifter LS converts the level of the voltage of a signal output from the logic circuit LOG, and outputs the resulting signal to the D/A conversion circuit DAC.

A bias circuit 120 shown in FIG. 4 generates a reference bias signal REFBS (bias voltage or bias current). The bias circuit 120 may include a reference voltage generation circuit that generates a reference voltage, a transistor to which the generated reference voltage is supplied at its gate, and the like.

Each of the repeater circuits REP1, REP2, and REP3 receives the reference bias signal REFBS, and supplies a bias signal generated based on the reference bias signal REFBS to the data line driver circuits (first to Lth data line driver circuits) included in the corresponding sub-driver blocks. For example, the repeater circuit REP1 supplies the bias signal generated based on the reference bias signal REFBS to the sub-driver blocks SDB0 and SDB1. Likewise, the repeater circuit REP2 supplies the bias signal generated based on the reference bias signal REFBS to the sub-driver blocks SDB2 and SDB3, and the repeater circuit REP3 supplies the bias signal generated based on the reference bias signal REFBS to the sub-driver blocks SDB4 and SDB5.

In FIG. 5, each of the repeater circuits REP includes a bias repeater circuit REPB. The bias repeater circuit REPB receives the reference bias signal REFBS, and supplies a bias signal BS generated based on the reference bias signal REFBS to the data line driver circuits GR, GG, and GB included in the corresponding sub-driver blocks SDB.

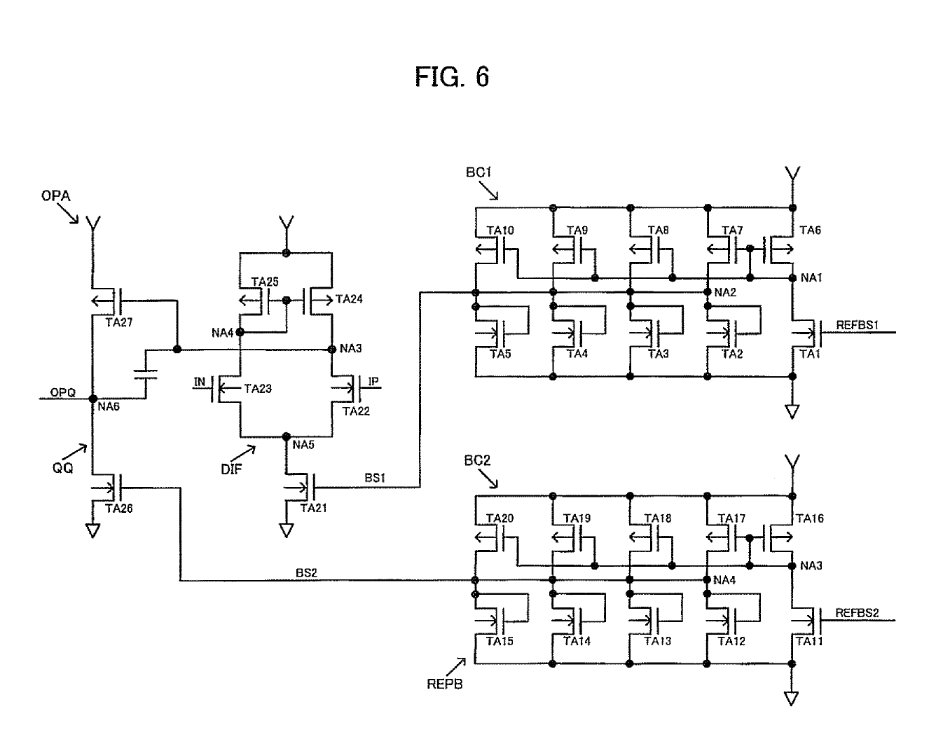

FIG. 6 shows a configuration example of the bias repeater circuit REPB. The bias repeater circuit REPB includes sub-bias circuits BC1 and BC2.

The sub-bias circuit BC1 includes N-type transistors TA1 to TA5 and P-type transistors TA6 to TA10. A first reference bias signal REFBS1 (bias voltage) output from the bias circuit 120 shown in FIG. 4 is input to the gate of the transistor TA1. A current corresponding to a current that flows through the transistor TA1 flows through the transistors TA2 to TA5 due to a current mirror formed by the transistors TA6 and TA7 to TA10 of which the gates are connected so that a first bias signal BS1 (bias voltage) is generated. The configuration and the operation of the sub-bias circuit BC2 are the same as those of the sub-bias circuit BC1. Specifically, the sub-bias circuit BC2 receives a second reference bias signal REFBS2 output from the bias circuit 120, and generates a second bias signal BS2.

Each data line driver circuit includes an operational amplifier OPA having a configuration shown in FIG. 6, for example. Note that the configuration of the operational amplifier OPA is not limited to FIG. 6. Various modifications may be made.

The operational amplifier OPA includes a differential section DIF that includes N-type transistors TA21, TA22, and TA23 and P-type transistors TA24 and TA25, and an output section QQ that includes an N-type transistor TA26 and a P-type transistor TA27. The bias signal BS1 output from the sub-bias circuit BC1 is input to the gate of the transistor TA21 that functions as a current source so that a bias current that flows through the differential section DIF is set. The bias signal BS2 output from the sub-bias circuit BC2 is input to the gate of the transistor TA26 that functions as a current source so that a bias current that flows through the output section QQ is set.

For example, when a bias signal supplied to a number of data line driver circuits is supplied using only the bias circuit 120 shown in FIG. 4, a bias current that flows through the transistors TA21 and TA26 (current sources) of the operational amplifier OPA changes due to a change in bias signal. In particular, a change in bias current is likely to occur when providing a number of data line driver circuits corresponding to the number of data lines of the electro-optical panel 400.

According to this embodiment, since the bias repeater circuit REPB is provided, the bias signals BS1 and BS2 supplied to the operational amplifier OPA are individually supplied from the sub-bias circuits BC1 and BC2 provided in the bias repeater circuit REPB. Therefore, since the number of operational amplifiers corresponding to each bias circuit can be reduced, a change in bias signal can be suppressed so that a change in bias current can be reduced.

In particular, when using a sample-hold circuit for the data line driver circuit (described later), the bias current may change to a large extent within a short period of time due to the operation of the operational amplifier OPA at the sample timing or the hold timing. A change in bias current causes an error in sampling voltage. As a result, the voltage of the data signal changes so that the display characteristics deteriorate. For example, when supplying the bias signal using only the bias circuit 120, the length of a bias signal line increases to a large extent. Therefore, a variation in the impedance of the bias signal line increases at the left end, center, and right end of the integrated circuit device 10 shown in FIG. 3. As a result, a variation in the voltage of the data signal also occurs so that a phenomenon such as display non-uniformity may occur.

According to this embodiment, since the bias repeater circuit REPB is provided, the length of the bias signal lines that supply the bias signals BS1 and BS2 can be significantly reduced as compared with the case of using only the bias circuit 120. Therefore, a variation in impedance can be reduced so that display non-uniformity or the like can be reduced. As a result, the display characteristics can be improved.

4. Layout of Sub-Driver Block

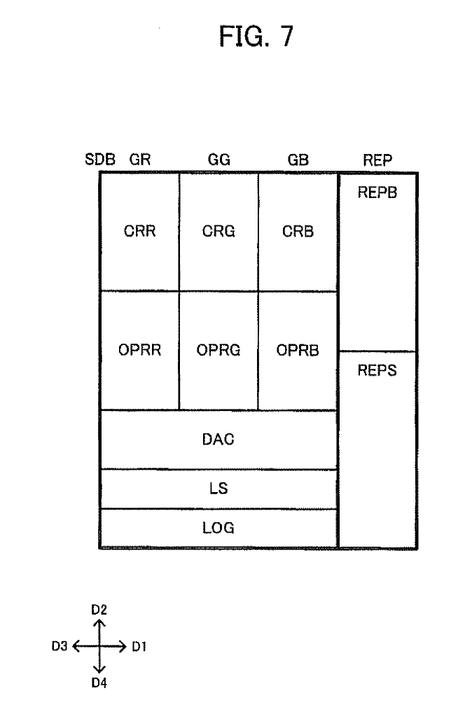

FIG. 7 shows a detailed layout example of the sub-driver block SDB. In FIG. 7, each of the data line driver circuits GR, GG, and GB includes the operational amplifier described with reference to FIG. 6, and at least one capacitor. The capacitor may be a sampling capacitor used for a sample-hold circuit described later, a phase-compensation capacitor for the operational amplifier, an auxiliary capacitor connected to a node of an inverting input terminal of the operational amplifier, or the like.

The operational amplifier of the data line driver circuit GR is disposed in an operational amplifier area OPRR, and the capacitor of the data line driver circuit GR is disposed in a capacitor area CRR. The capacitor area CRR is provided in the direction D2 with respect to the operational amplifier area OPRR. Specifically, the operational amplifier area OPRR is formed between an area of the D/A conversion circuits DAC and the capacitor area CRR. The above description also applies to operational amplifier areas OPRG and OPRB and capacitor areas CRG and CRB of the data line driver circuits GG and GB. When the data line driver circuit includes a sample-hold circuit, a switch element area in which a switch element (transfer gate) used for the sample-hold circuit is disposed may be formed between the operational amplifier area and the capacitor area.

According to the layout shown in FIG. 7, the capacitors are collectively disposed in the capacitor areas CRR, CRG, and CRB. Therefore, other capacitors can be adjacently disposed around each capacitor, for example. As a result, the openings between the capacitors can be formed at almost the same etching rate, for example, so that the capacitors can be formed with high accuracy.

The layout efficiency can be improved by separately disposing the operational amplifier and the capacitor, as shown in FIG. 7. Moreover, since other signal lines can be provided over the capacitor areas CRR, CRG, and CRB shown in FIG. 7, the layout efficiency can be further improved.

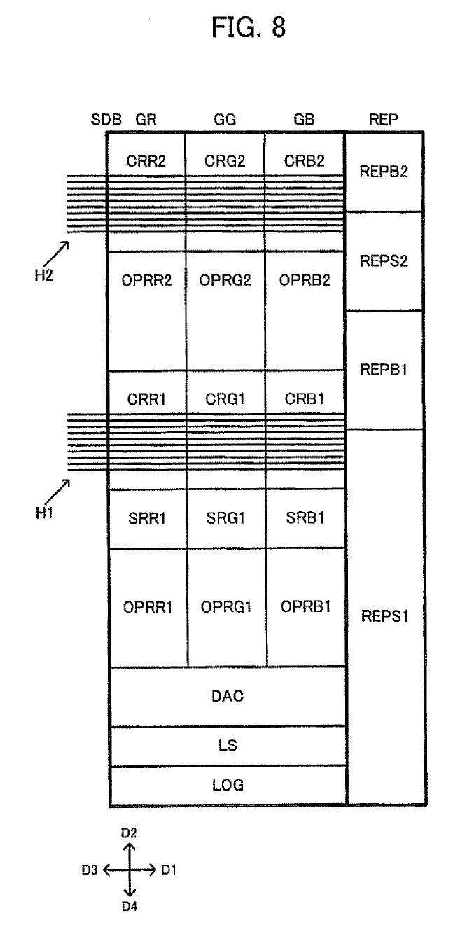

FIG. 8 shows a further detailed layout example of the sub-driver block SDB. In FIG. 8, each of the data line driver circuits GR, GG, and GB includes a grayscale generation amplifier and a driver amplifier formed using a flip-around sample-hold circuit (described later). An operational amplifier, a switch element, and a capacitor of the grayscale generation amplifier of the data line driver circuit GR are respectively formed in an operational amplifier area OPRR1, a switch element area SRR1, and a capacitor area CRR1. An operational amplifier and a capacitor of the driver amplifier of the data line driver circuit GR are respectively formed in an operational amplifier area OPRR2 and a capacitor area CRR2, and a switch element of the driver amplifier is formed in the operational amplifier area OPRR2. The areas OPRR1, SRR1, CRR1, OPRR2, and CRR2 are provided in this order along the direction D2. The above description also applies to the layout of operational amplifier areas OPRG1, OPRG2, OPRB1, OPRB2, switch element areas SRG1 and SRB1, and capacitor areas CRG1, CRB1, CRG2, and CRB2 of the data line driver circuits GG and GB.

As indicated by H1 and H2 in FIG. 8, a plurality of repeater circuit signal lines (other signal lines) are provided across the capacitor areas CRR1 to CRB1 and CRR2 to CRB2 along the direction D1. The repeater circuit signal lines include signal lines that transmit the control signal SGL output from the logic circuit 40 shown in FIG. 4 to the repeater circuits REP1 to REP3, for example.

According to this layout, since the repeater circuit signal lines can be provided by effectively utilizing the space of the capacitor areas CRR1 to CRB1 and CRR2 to CRB2, the layout efficiency can be improved. Therefore, the width W of the integrated circuit device 10 in the direction D2 can be reduced, for example.

If the repeater circuit signal lines are provided across the operational amplification areas OPRR1 to OPRB1 and OPRR2 to OPRB2 or the switch element areas SRR1 to SRB1, a change in voltage level of the repeater circuit signal lines may be transmitted as noise to transistors and lines disposed in these areas through parasitic capacitors. Such noise may cause circuit malfunction, a deterioration in display quality, and the like.

In FIG. 8, since the repeater circuit signal lines are provided across the capacitor areas, parasitic capacitors formed between transistors and lines disposed in the operational amplifier areas and the switch element areas and the repeater circuit signal lines can be substantially eliminated. Therefore, circuit malfunction, a deterioration in display quality, and the like can be prevented so that a reduction in circuit scale and an improvement in display quality can be achieved.

5. Sample-Hold Circuit

Each of the data line driver circuits GR, GG, and GB shown in FIG. 7 may include a sample-hold circuit that includes an operational amplifier (OPRR to OPRB). Even if the D/A conversion circuit DAC outputs the grayscale voltages corresponding to the subpixel image data by time division, each of the data line driver circuits GR, GG, and GB can sample and hold the grayscale voltage by utilizing such a sample-hold circuit. Specifically, the D/A conversion circuit DAC outputs the R, G, and B grayscale voltages corresponding to the R, G, and B subpixel image data by time division in the first to third sample periods (first to Lth sample periods), for example. In this case, the sample-hold circuits of the data line driver circuits GR, GG, and GB sample the R, G, and B grayscale voltages output from the D/A conversion circuit DAC in the first to third sample periods, respectively. The sample-hold circuit outputs an output voltage corresponding to the sampled grayscale voltage in a hold period. This makes it possible for the data line driver circuits GR, GG, and GB to share the D/A conversion circuit DAC so that the layout area can be reduced.

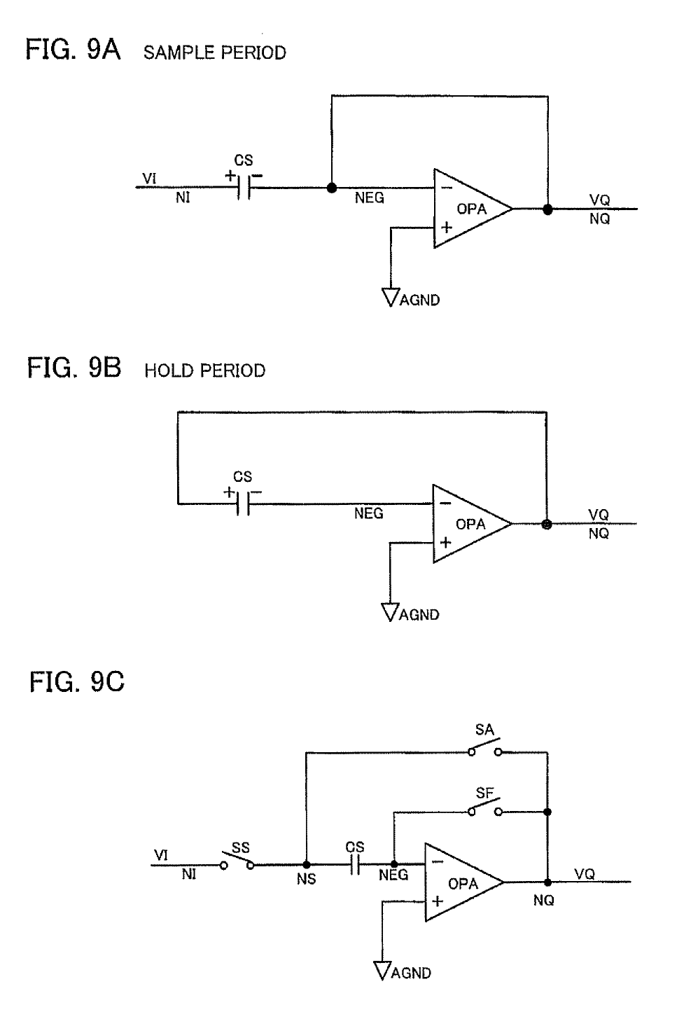

A flip-around sample-hold circuit may be used as the sample-hold circuit included in each of the data line driver circuits GR, GG, and GB, for example. The flip-around sample-hold circuit is described in detail below with reference to FIGS. 9A and 9B.

In FIGS. 9A and 9B, the flip-around sample-hold circuit includes an operational amplifier OPA and a sampling capacitor CS. The sampling capacitor CS is provided between an inverting input terminal (first input terminal in a broad sense) of the operational amplifier OPA and an input node NI of the sample-hold circuit. As shown in FIG. 9A, a charge corresponding to an input voltage VI at the input node NI is stored in the capacitor CS in the sample period.

As shown in FIG. 9A, the output from the operational amplifier OPA is fed back to a node NEG of the inverting input terminal of the operational amplifier OPA in the sample period. An analog reference power supply voltage AGND is supplied to a non-inverting input terminal (second input terminal in a broad sense) of the operational amplifier OPA. Therefore, the node NEC connected to one end of the capacitor CS is set at the voltage AGND due to a virtual short circuit function of the operational amplifier OPA. Therefore, a charge corresponding to the input voltage VI is stored in the capacitor CS.

As shown in FIG. 9B, the sample-hold circuit outputs an output voltage VQ corresponding to the charge stored in the sampling capacitor CS in the sample period to its output node NQ in the hold period. Specifically, the sample-hold circuit outputs the output voltage VQ corresponding to the charge stored in the capacitor CS by performing a flip-around operation that connects the other end of the capacitor CS of which one end is connected to the node NEG to an output terminal of the operational amplifier OPA.

An offset-free state can be implemented by utilizing the above-described flip-around sample-hold circuit (details are described later). Therefore, a variation in output voltage between the data lines can be minimized so that an accurate voltage that varies to only a small extent can be supplied to the data line. As a result, the display quality can be improved. Moreover, since a DAC drive operation that directly drives the data line using the D/A conversion circuit becomes unnecessary, high-speed drive and simplified control can be implemented.

FIG. 9C shows a detailed configuration example of the flip-around sample-hold circuit. The sample-hold circuit includes the operational amplifier OPA, a sampling switch element SS, the sampling capacitor CS, a feedback switch element SF, and a flip-around switch element SA. Note that modifications may be made such as omitting some of these elements or adding other elements. The switch elements SS, SA, and SF may be formed by CMOS transistors (e.g., transfer gate), for example.

The analog reference power supply voltage AGND is supplied to the non-inverting input terminal (second input terminal) of the operational amplifier OPA.

The sampling switch element SS and the sampling capacitor CS are provided between the input node NI of the sample-hold circuit and the inverting input terminal (first input terminal) of the operational amplifier OPA. The feedback switch element SF is provided between the output terminal and the inverting input terminal of the operational amplifier OPA.

The flip-around switch element SA is provided between a connection node NS situated between the switch element SS and the capacitor CS, and the output terminal of the operational amplifier OPA.

In the sample period, the sampling switch element SS and the feedback switch element SF are turned ON, and the flip-around switch element SA is turned OFF, as shown in FIG. 9A. This implements a sampling operation of the flip-around sample-hold circuit.

In the hold period, the sampling switch element SS and the feedback switch element SF are turned OFF, and the flip-around switch element SA is turned ON, as shown in FIG. 9B. This implements a hold operation of the flip-around sample-hold circuit.

In the flip-around sample-hold circuit shown in FIG. 9C, charge injection due to the feedback switch element SF occurs (details are described later). However, imbalance between the amount of charge from the N-type transistor and the amount of charge from the P-type transistor of the transfer gate of the feedback switch element SF can be reduced by supplying the analog reference power supply voltage AGND (i.e., a voltage between a high-potential-side power supply voltage VDDHS and a low-potential-side power supply voltage VSS) to the non-inverting input terminal of the operational amplifier OPA, as shown in FIG. 9B. This minimizes an adverse effect of charge injection that may occur when the switch element SF is turned OFF.

6. Another Example of Layout of Integrated Circuit Device

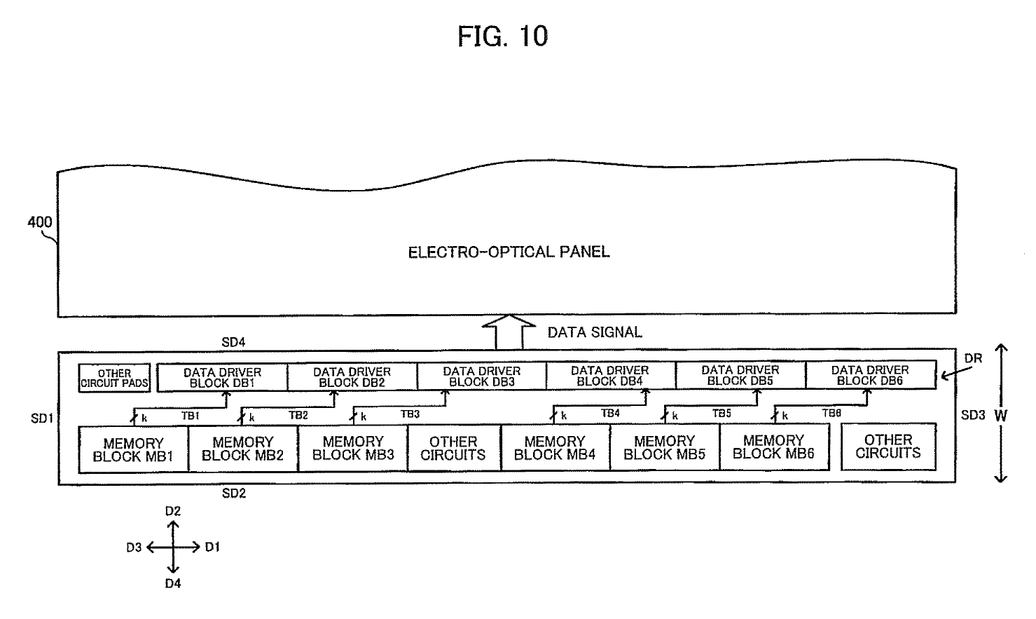

FIG. 10 shows another example of the layout of the integrated circuit device 10. The integrated circuit device 10 shown in FIG. 10 includes a plurality of memory blocks MB1 to MB6 (first to Nth memory blocks in a broad sense) in addition to the data driver blocks DB1 to DB6 shown in FIG. 3. The memory blocks MB1 to MB6 store image data for displaying an image. The memory blocks MB1 to MB6 are disposed (arranged) along the direction D1 in the direction D4 with respect to the data driver blocks DB1 to DB6.

Specifically, the memory 20 shown in FIG. 1 is divided into the memory blocks MB1 to MB6 in a bank. The memory blocks MB1 to MB6 (memory cell arrays) store image data corresponding to data signals supplied to a first data line group to a sixth data line group of the electro-optical panel 400, respectively. The number of memory blocks MB1 to MB6 is not limited to six, but may be an arbitrary number. The column address decoder, the row address decoder, a sense amplifier block, and the like provided in each memory block together with the memory cell array may be independently provided in each memory block. Alternatively, the memory blocks may share some or all of the column address decoder, the row address decoder, a sense amplifier block, and the like.

The data driver blocks DB1 to DB6 (first to Nth data driver blocks) are disposed along the direction D1 in the direction D2 with respect to the memory blocks MB1 to MB6. The data driver blocks DB1 to DB6 supply the data signals to the data lines of the electro-optical panel 400 (electro-optical device). The memory block MB1 stores image data necessary for the data driver block DB1 to generate the data signals, and the memory block MB2 stores image data necessary for the data driver block DB2 to generate the data signals. Likewise, the memory blocks MB3 to MB6 store image data necessary for the data driver blocks DB3 to DB6 to generate the data signals.

The memory block MB1 (Jth memory block in a broad sense; J is an integer that satisfies 1≦J≦N) among the memory blocks MB1 to MB6 (first to Nth memory blocks) dot-sequentially reads subpixel image data (i.e., image data corresponding to at least one subpixel (e.g., one to eight subpixels) from the memory cell array. The memory block MB1 outputs the read subpixel image data by time division to the corresponding data driver block DB1 (Jth data driver block in a broad sense) among the data driver blocks DB1 to DB6. Specifically, the image data is dot-sequentially read from a port of the memory block MB1 (data driver-side port) instead of line-sequentially reading the image data.

Specifically, a k-bit (k is a natural number; e.g., k=8, 16, or 32) data transfer bus TB1 that transfers the subpixel image data (R, G, and B image data) by time division is provided between the memory block MB1 and the data driver block DB1. The k-bit subpixel image data is transferred through the data transfer bus TB1.

The data driver block DB1 receives the subpixel image data from the memory block MB1, and outputs the data signals corresponding to the subpixel image data.

Likewise, the memory block MB2 dot-sequentially reads the subpixel image data, and outputs the subpixel image data to the corresponding data driver block DB2 by time division. Specifically, a k-bit data transfer bus TB2 that transfers the subpixel image data by time division is provided between the memory block MB2 and the data driver block DB2. The k-bit subpixel image data is transferred through the data transfer bus TB2.

The data driver block DB2 receives the subpixel image data from the memory block MB2, and outputs the data signals corresponding to the subpixel image data.

Likewise, the subpixel image data is transferred by time division between the memory blocks MB3 to MB6 and the corresponding data driver blocks DB3 to DB6 through data transfer buses TB3 to TB6.

Note that the subpixel image data is transferred in parallel between the memory blocks MB1 to MB6 and the data driver blocks DB1 to DB6 in each horizontal scan period. For example, the image data supplied to the subpixels corresponding to the intersection points of the first scan line and the second data line group adjacent to the first data line group is transferred between the memory block MB2 and the data driver block DB2 in a period in which the image data supplied to the subpixels corresponding to the intersection points of the first scan line and the first data line group is transferred between the memory block MB1 and the data driver block DB1. The above description also applies to data transfer between the memory blocks MB3 to MB6 and the data driver blocks DB3 to DB6, respectively.

According to this embodiment, the image data is dot-sequentially read from the memory (RAM) instead of line-sequentially reading the image data from the memory. The subpixel image data that is dot-sequentially read from each memory block is transferred to the corresponding data driver block by time division. This eliminates the dependence on the positional relationship between the memory blocks MB1 to MB6 and the data driver blocks DB1 to DB6 so that the data driver blocks DB1 to DB6 can be disposed without being affected by the layout of the memory blocks MB1 to MB6. Therefore, the degree of freedom relating to the layout can be increased so that the layout efficiency can be improved. As a result, the width W of the integrated circuit device 10 in the direction D2 can be reduced so that a narrow chip can be implemented. This reduces the chip area of the integrated circuit device 10, and facilitates mounting of the integrated circuit device 10.

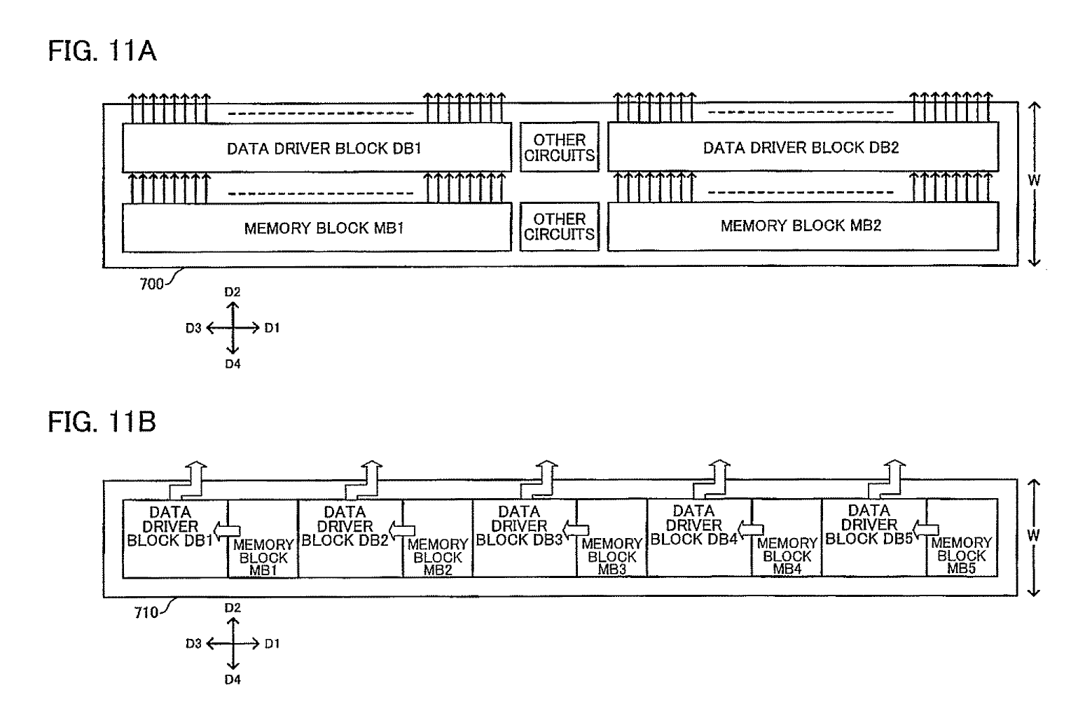

FIGS. 11A and 11B show integrated circuit devices according to comparative examples of this embodiment. In an integrated circuit device 700 shown in FIG. 11A, the data driver block DB1 is disposed in the direction D2 with respect to the memory block MB1, and the data driver block DB2 is disposed in the direction D2 with respect to the memory block MB2. Other circuits are disposed between the memory blocks MB1 and MB2 and between the data driver blocks DB1 and DB2.

In FIG. 11A, the image data is line-sequentially read from the memory block MB1. The image data (image data corresponding to one line) is simultaneously read from the memory block MB1 at a given timing, and output to the data driver block DB1. Likewise, the image data is line-sequentially read from the memory block MB2. The image data is simultaneously read from the memory block MB2 at a given timing, and output to the data driver block DB2. Therefore, the memory block MB1 and the data driver block DB1 are connected via signal lines in the same number as the number of the corresponding data lines (e.g., half of the data lines of the electro-optical panel), and the memory block MB2 and the data driver block DB2 are connected via signal lines in the same number as the number of the corresponding data lines. Specifically, since the number of signal lines is very large, the degree of freedom relating to the layout of the memory blocks MB1 and MB2 and the data driver blocks DB1 and DB2 decreases. For example, when the memory block MB1 and the data driver block DB1 are disposed so that the center position of the memory block MB1 does not coincide with the center position of the data driver block DB1 in the direction D1, the width W of the integrated circuit device 700 in the direction D2 increases to a large extent due to the wiring area of the signal lines that connect the memory block MB1 and the data driver block DB1. This makes it difficult to reduce the width W to implement a narrow chip. In particular, it is difficult to deal with an increase in the number of the data lines of the electro-optical panel aimed to increase the degree of definition.

In an integrated circuit device 710 shown in FIG. 11B (JP-A-2007-243125), the memory block MB1 and the data driver block DB1 are disposed adjacently along the direction D1. This also applies to the layout of the memory blocks MB2 to MB5 and the data driver blocks DB2 to DB5.

The integrated circuit device 710 shown in FIG. 11B has an advantage over the integrated circuit device 700 shown in FIG. 11A in that the degree of freedom relating to the layout can be increased so that the width W of the integrated circuit device in the direction D2 can be reduced.

However, since the signal lines from each memory block to each data driver block are provided along the direction D1 (D3) in FIG. 11B, the layout area of each data driver block increases due to the signal lines and the like. Moreover, it is necessary to rearrange the lines that connect the output signal lines of each data driver block to the data signal pads. Therefore, the width W of the integrated circuit device in the direction D2 cannot be reduced to a large extent due to rearrangement of the lines.

In FIG. 10, the image data is dot-sequentially read from each memory block. Therefore, the number of lines of the data transfer bus (TB1 to TB6) that connects each memory block and each data driver block is k (i.e., the number of lines of the data transfer bus is significantly smaller than the number of signal lines that connect each memory block and each data driver block in FIG. 11A). Therefore, the degree of freedom relating to the layout is higher than that of FIG. 11A.

In FIG. 10, the Jth memory block among the plurality of memory blocks and the Jth data driver block among the plurality of data driver blocks can be disposed so that the center position of the Jth memory block does not coincide with the center position of the Jth data driver block in the direction D1, for example. Therefore, other circuits other than the memory blocks and the data driver blocks, pads (terminals in a broad sense), and the like can be disposed in the space formed by the above-mentioned layout (i.e., the center position of the Jth memory block does not coincide with the center position of the Jth data driver block in the direction D1) so that the layout efficiency can be improved.

For example, a space can be formed in the direction D1 with respect to the memory block MB6 (Nth memory block) and in the direction D4 with respect to the data driver block DB6 (Nth data driver block) by disposing the memory blocks MB1 to MB6 and the data driver blocks DB1 to DB6 as shown in FIG. 10. Therefore, other circuits such as a grayscale voltage generation circuit and a logic circuit can be disposed in the resulting space.

Moreover, a space can be formed in the direction D2 with respect to the memory block MB1 (first memory block) and in the direction D3 with respect to the data driver block DB1 (first data driver block) by disposing the memory blocks MB1 to MB6 and the data driver blocks DB1 to DB6 as shown in FIG. 10. Therefore, a plurality of scan signal pads used to supply a scan signal to a plurality of scan lines of the electro-optical panel 400 (electro-optical device) can be disposed in the resulting space, for example. Therefore, the layout efficiency can be improved by effectively utilizing the space.

In FIG. 10, the number k of lines of the data transfer bus TB3 provided between the memory block MB3 and the data driver block DB3 is as small as eight or sixteen (k=8 or 16), and the number k of lines of the data transfer bus TB4 provided between the memory block MB4 and the data driver block DB4 is as small as eight or sixteen (k=8 or 16), for example. Therefore, a space can be formed between the memory blocks MB3 and MB4 by disposing the memory block MB3 at a position shifted in the direction D3 and disposing the memory block MB4 at a position shifted in the direction D1, for example. Therefore, other circuits such as a power supply circuit PB can be disposed in the resulting space. The impedance of the analog reference power supply voltage AGND that is output from an AGND output circuit of the power supply circuit PB and supplied to the data driver DR can be made uniform by thus disposing the power supply circuit PB. This prevents a deterioration in display characteristics so that the layout efficiency and the display characteristics can be improved.

In the comparative example shown in FIG. 11B, it is necessary to provide a number of signal lines in each data driver block from each memory block. In FIG. 10, it is unnecessary to provide such signal lines. Therefore, the area of each data driver block can be significantly reduced as compared with FIG. 11B. As a result, the width W the integrated circuit device 10 in the direction D2 can be reduced so that a narrow chip can be implemented while reducing the chip area. In FIG. 11B, it is necessary to rearrange the output signal lines from each data driver block. In FIG. 10, it is unnecessary to rearrange the output signal lines. Therefore, an increase in the width W the integrated circuit device 10 due to the rearrangement area can be prevented so that the width of the integrated circuit device 10 can be further reduced.

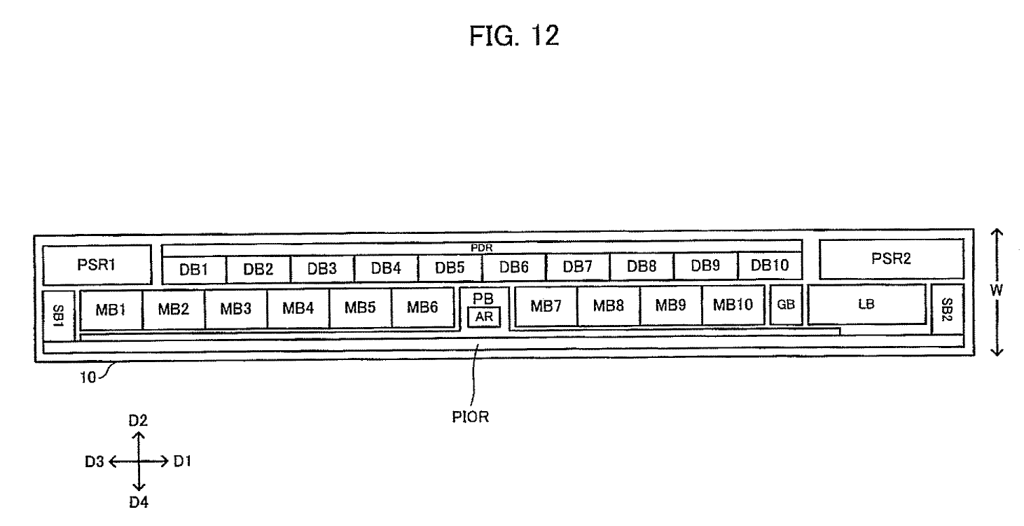

FIG. 12 shows a detailed layout example of the integrated circuit device 10 according to this embodiment. Note that the layout shown in FIG. 12 is only an example. The layout according to this embodiment is not limited to FIG. 12.

In FIG. 12, memory blocks MB1 to MB10 (first to Nth memory blocks) are disposed along the direction D1. Data driver blocks DB1 to DB10 are disposed along the direction D1 in the direction D2 with respect to the memory blocks MB1 to MB10. Each of the memory blocks MB1 to MB10 and the corresponding data driver block among the data driver blocks DB1 to DB10 are disposed so that the center position of the memory block is shifted in the direction D1 with respect to the center position of the data driver block. Specifically, the right end of each of the memory blocks MB1 to MB10 does not coincide with the right end of each of the data driver blocks DB1 to DB10 in the direction D1, and the left end of each of the memory blocks MB1 to MB10 does not coincide with the left end of each of the data driver blocks DB1 to DB10 in the direction D1.

A grayscale voltage generation circuit GB generates a plurality of grayscale voltages, and supplies the grayscale voltages to the data driver blocks DB1 to DB10. Grayscale voltage signal lines are provided over the memory blocks MB1 to MB10, for example. In FIG. 12, the grayscale voltage generation circuit GB is disposed in the direction D1 with respect to the rightmost memory block MB10 (Nth memory block) and is disposed in the direction D4 with respect to the rightmost data driver block DB10 (Nth data driver block). According to this layout, the grayscale voltage generation circuit GB can be disposed by effectively utilizing such a space.

A scan driver SB1 disposed on the left end of the integrated circuit device 10 generates a scan signal. The scan signal is supplied to the scan line of the electro-optical panel 400 through a scan signal pad disposed in a scan signal pad area PSR1. A scan driver SB2 disposed on the right end of the integrated circuit device 10 generates a scan signal. The scan signal is supplied to the scan line of the electro-optical panel 400 through a scan signal pad disposed in a scan signal pad area PSR2.

In FIG. 12, a plurality of scan signal pads (area PSR1) used to supply the scan signal to the scan line are disposed in the direction D2 with respect to the leftmost memory block MB1 (first memory block) and are disposed in the direction D3 with respect to the leftmost data driver block DB1 (first data driver block). According to this layout, a number of scan signal pads can be disposed in the area PSR1 by effectively utilizing such a space.

In FIG. 12, an AGND output circuit AR is disposed between the memory block MB6 (Mth memory block) and the memory block MB7 ((M+1)th memory block). An AGND line from the AGND output circuit AR is provided along the direction D1 over the data driver blocks DB1 to DB10. Therefore, the impedance of the AGND line can be made uniform.

In FIG. 12, a data signal pad arrangement area PDR (first interface area; output-side I/O area) is provided in the direction D2 with respect to the data driver blocks DB1 to DB10. A logic circuit LB pad (I/O pad), a voltage-booster pad connected to a voltage-booster capacitor for the power supply circuit PB, and a power supply pad connected to a power supply stabilization capacitor are disposed in a pad area PIOR (second interface area; input-side I/O area) provided in the direction D4 with respect to the memory blocks MB1 to MB10. A voltage-booster transistor (voltage booster circuit) of the power supply circuit PB is disposed in a narrow area between the memory blocks MB1 to MB10 and the pad area PIOR. Therefore, the drain of the voltage-booster transistor can be connected to the voltage-booster pad along a short path, for example.

7. Details of Data Transfer

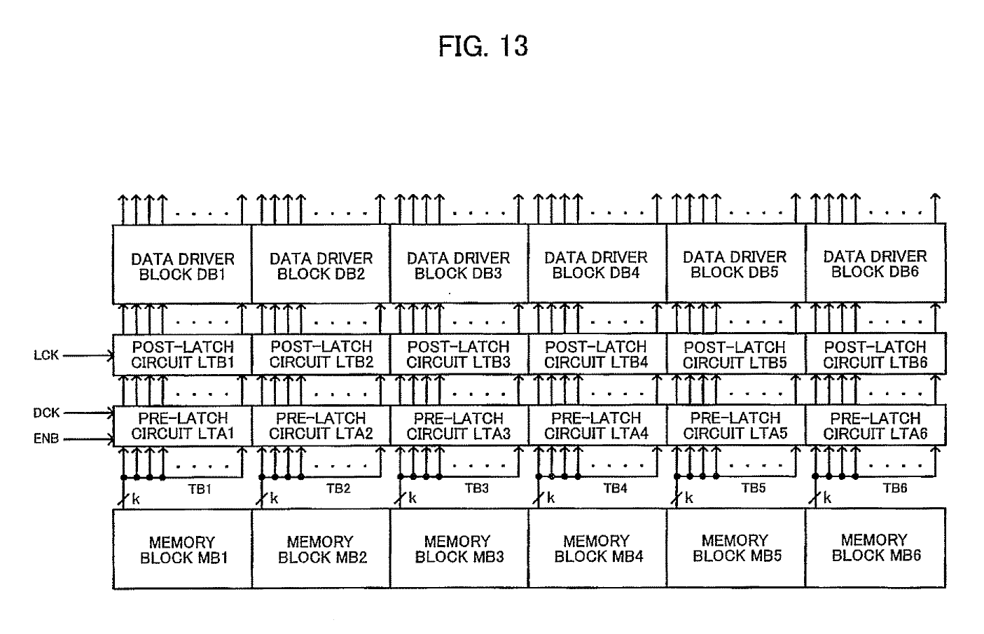

The details of data transfer between the data driver block and the memory block are described below. In FIG. 13, a latch circuit is provided between the memory blocks MB1 to MB6 (first to Nth memory blocks) and the data driver blocks DB1 to DB6 (first to Nth memory blocks). Specifically, pre-latch circuits LTA1 to LTA6 (first to Nth pre-latch circuits in a broad sense) and post-latch circuits LTB1 to LTB6 (first to Nth post-latch circuits in a broad sense) are provided.

The pre-latch circuit LTA1 (Jth pre-latch circuit in a broad sense) among the pre-latch circuits LTA1 to LTA6 (latch circuits in the preceding stage) sequentially latches the subpixel image data output from the memory block MB1 (Jth memory block) by time division. Specifically, the pre-latch circuit LTA1 sequentially latches the k-bit subpixel image data from a left flip-flop circuit to a right flip-flop circuit among a plurality of k-bit flip-flop circuits (registers) included in the pre-latch circuit LTA1 using a clock signal DCK. Specifically, the pre-latch circuit LTA1 sequentially latches the k-bit subpixel image data by the flip-flop circuits that are latch-enabled based on an enable signal ENB. When each piece of R data, G data, and B data contained in the subpixel image data is 8-bit data, k=8 when the image data corresponding to one subpixel is transferred, and k=16 when the image data corresponding to two subpixels is transferred.

The post-latch circuit LTB1 (Jth post-latch circuit in a broad sense) among the post-latch circuits LTB1 to LTB6 (latch circuits in the subsequent stage) line-sequentially reads and latches the subpixel image data from the pre-latch circuit LTA1 (Jth pre-latch circuit) after the pre-latch circuit LTA1 has latched the subpixel image data. The post-latch circuit LTB1 outputs the latched subpixel image data to the data driver block DB1 (Jth data driver block). Specifically, the post-latch circuit LTB1 simultaneously reads and latches the entire subpixel image data latched by the pre-latch circuit LTA1 using a latch clock signal LCK. The post-latch circuit LTB1 outputs the latched subpixel image data to the data driver block DB1.

The pre-latch circuit LTA2 sequentially latches the subpixel image data output from the memory block MB2 by time division. The post-latch circuit LTB2 line-sequentially reads and latches the subpixel image data from the pre-latch circuit LTA2 after the pre-latch circuit LTA2 has latched the subpixel image data. The post-latch circuit LTB2 outputs the latched subpixel image data to the data driver block DB2. The operations of the pre-latch circuits LTA3 to LTA6 and the post-latch circuits LTB3 to LTB6 are the same as described above. The latch operations of the pre-latch circuits LTA1 to LTA6 are performed in parallel at the same timing, and the latch operations of the post-latch circuits LTB1 to LTB6 are performed in parallel at the same timing.

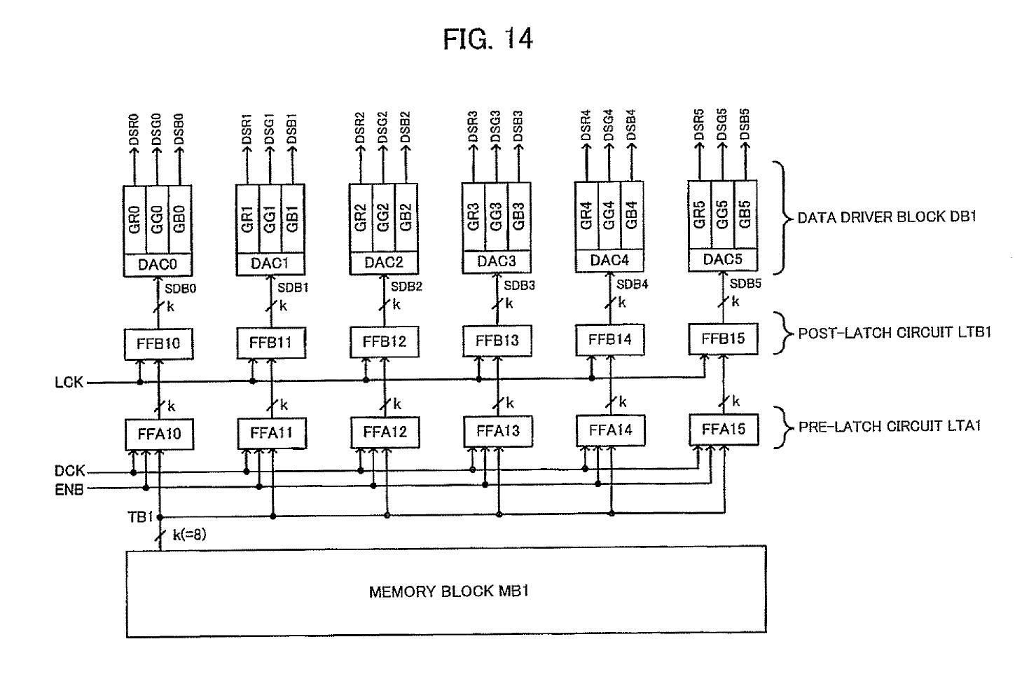

FIG. 14 shows a detailed configuration example of the pre-latch circuit LTA1, the post-latch circuit LTB1, and the data driver block DB1. The detailed configuration of the pre-latch circuits LTA2 to LTA6, the post-latch circuits LTB2 to LTB6, and the data driver blocks DB2 to DB6 is the same as that shown in FIG. 14. Therefore, description thereof is omitted.

The pre-latch circuit LTA1 (Jth pre-latch circuit) includes a plurality of flip-flop circuits FFA10 to FFA15. Each of the flip-flop circuits FFA10 to FFA15 is a circuit (register) that can hold the k-bit (=8-bit) subpixel image data.

The post-latch circuit LTB1 (Jth post-latch circuit) includes a plurality of flip-flop circuits FFB10 to FFB15. Each of the flip-flop circuits FFB10 to FFB15 is a circuit (register) that can hold the k-bit (=8-bit) subpixel image data.

The data driver block DB1 (Jth data driver block) includes a plurality of sub-driver blocks SDB0 to SDB5. Each of the sub-driver blocks SDB0 to SDB5 outputs the data signal corresponding to at least one pixel based on the subpixel image data output from the memory block MB1 (Jth memory block). For example, the sub-driver block SDB0 outputs the R, G, and B data signals DSR0, DSG0, and DSB0 corresponding to one pixel based on the subpixel image data. Likewise, the sub-driver block SDB1 outputs the R, G, and B data signals DSR1, DSG1, and DSB1 corresponding to one pixel. The above description also applies to the sub-driver blocks SDB2 to SDB5.

In FIG. 14, each of the sub-driver blocks SDB0 to SDB5 includes a D/A conversion circuit and a plurality of data line driver circuits (subpixel driver cells or grayscale amplifiers) that share the D/A conversion circuit.

For example, the sub-driver block SDB0 includes the D/A conversion circuit DAC0 and the data line driver circuits GR0, GG0, and GB0 that share the D/A conversion circuit DAC0 by time division. The data line driver circuits GR0, GG0, and GB0 are R, G, and B data line driver circuits, respectively. The data line driver circuits GR0, GG0, and GB0 output the R, G, and B data signals DSR0, DSG0, and DSB0, respectively.

The sub-driver block SDB1 includes the D/A conversion circuit DAC1 and the data line driver circuits GR1, GG1, and GB1 that share the D/A conversion circuit DAC1 by time division. The data line driver circuits GR1, GG1, and GB1 are R, G, and B data line driver circuits, respectively. The data line driver circuits GR1, GG1, and GB1 output the R, G, and B data signals DSR1, DSG1, and DSB1, respectively. The above description also applies to the sub-driver blocks (cells) SDB2 to SDB5. The data signals DSR1, DSG1, and DSB1 are data signals corresponding to a pixel adjacent to the pixel corresponding to the data signals DSR0, DSG0, and DSB0, and the data signals DSR2, DSG2, and DSB2 are data signals corresponding to a pixel adjacent to the pixel corresponding to the data signals DSR1, DSG1, and DSB1.

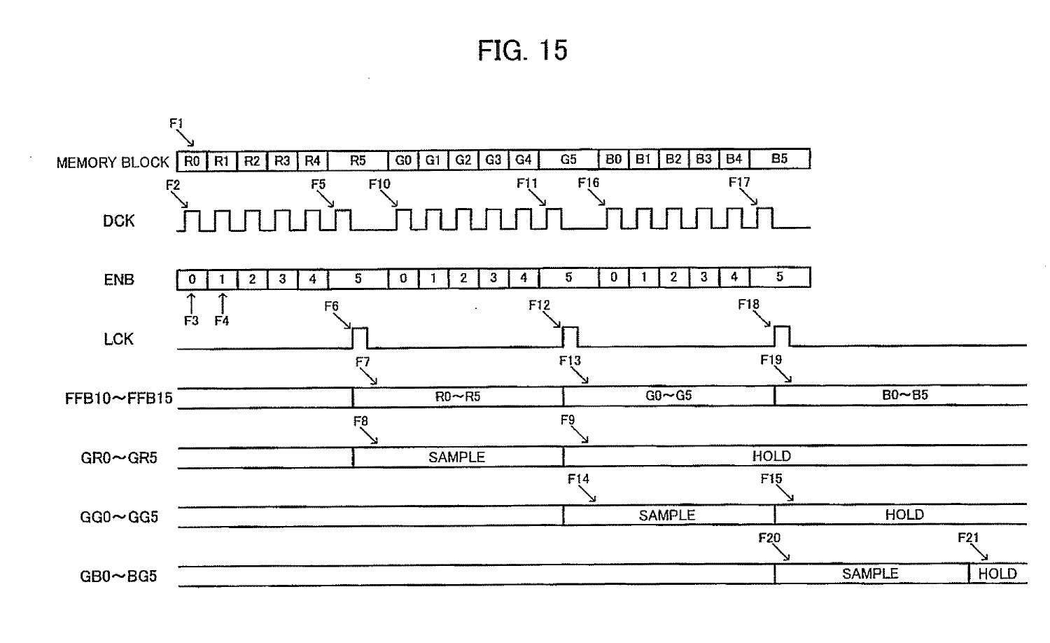

The operations of the circuits shown in FIG. 14 are described below using a signal waveform example shown in FIG. 15. As indicated by F1 in FIG. 15, the memory block MB1 dot-sequentially reads the k-bit (=8-bit) subpixel image data R0 to R5, and outputs the subpixel image data R0 to R5 by time division. As indicated by F2, the pre-latch circuit LTA1 (Jth pre-latch circuit) sequentially latches the R (first color component in a broad sense) subpixel image data R0 to R5 output from the memory block MB1 (Jth memory block) by time division. Specifically, when the enable signal ENB indicates “0” (F3), the flip-flop circuit FFA10 shown in FIG. 14 latches the subpixel image data R0 using the clock signal DCK. When the enable signal ENB indicates “1” (F4), the flip-flop circuit FFA11 adjacent to the flip-flop circuit FFA10 latches the subpixel image data R1 using the clock signal DCK. Likewise, when the enable signal ENB indicates “2”, “3”, “4”, or “5”, the flip-flop circuit FFA12, FFA13, FFA14, or FFA15 respectively latches the subpixel image data R2, R3, R4, or R5 using the clock signal DCK.

After the pre-latch circuit LTA1 has latched the R (first color component) subpixel image data R0 to R5 (F5), the post-latch circuit LTB1 (Jth post-latch circuit) line-sequentially reads and latches the subpixel image data R0 to R5 from the pre-latch circuit LTA1 (F6). Specifically, the flip-flop circuits FFB11 to FFB15 of the post-latch circuit LTB1 simultaneously latch the subpixel image data R0 to R5 latched by the flip-flop circuits FFA10 to FFA15 of the pre-latch circuit LTA1 using the latch clock signal LCK.

When the post-latch circuit LTB1 has latched the R subpixel image data R0 to R5 (F7), the data driver block DB1 (Jth data driver block) samples the signal (voltage) corresponding to the latched subpixel image data R0 to R5 (F8). The data driver block DB1 then holds the sampled voltage (F9). Specifically, the D/A conversion circuits DAC0 to DAC5 of the sub-driver blocks SDB0 to SDB5 respectively D/A-convert the subpixel image data R0 to R5. Each of the R data line driver circuits GR0 to GR5 (sample-hold circuits) of the sub-driver blocks SDB0 to SDB5 then samples and holds the voltage obtained by D/A conversion.

The pre-latch circuit LTA1 then sequentially latches the G (second color component in a broad sense) subpixel image data G0 to G5 output from the memory block MB1 by time division (F10).

After the pre-latch circuit LTA1 has latched the subpixel image data G0 to G5 (F11), the post-latch circuit LTB1 line-sequentially reads and latches the latched subpixel image data G0 to G5 from the pre-latch circuit LTA1 (F12).

When the post-latch circuit LTB1 has latched the subpixel image data G0 to G5 (F13), the data driver block DB1 samples the signal (voltage) corresponding to the latched subpixel image data G0 to G5 (F14). The data driver block DB1 then holds the sampled voltage (F15).

The pre-latch circuit LTA1 then sequentially latches the B (third color component in a broad sense) subpixel image data B0 to B5 output from the memory block MB1 by time division (F16).

After the pre-latch circuit LTA1 has latched the subpixel image data B0 to B5 (F17), the post-latch circuit LTB1 line-sequentially reads and latches the latched subpixel image data B0 to B5 from the pre-latch circuit LTA1 (F18).

When the post-latch circuit LTB1 has latched the subpixel image data B0 to B5 (F19), the data driver block DB1 samples the signal (voltage) corresponding to the latched subpixel image data B0 to B5 (F20). The data driver block DB1 then holds the sampled voltage (F21).

According to the method shown in FIG. 15, the R subpixel image data, the G subpixel image data, and the B subpixel image data can be sequentially latched in the order of R, G, and B, and input to the data driver block DB1. The data driver block DB1 samples and holds the signals (voltages) corresponding to the R, G, and B subpixel image data.

Therefore, when the R, G, and B grayscale characteristics differ from one another, gamma correction corresponding to R, G, and B can be independently implemented by causing the grayscale voltage generation circuit 110 shown in FIG. 2B to output the R, G, and B grayscale voltages by time division. As a result, the display quality can be improved.

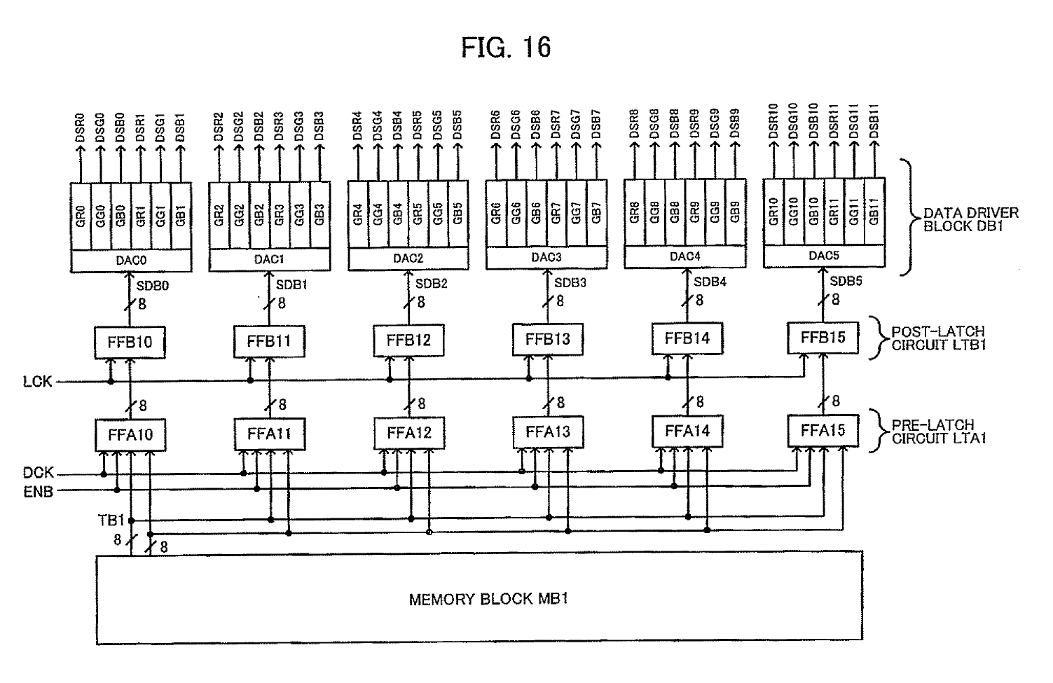

The above description has been given taking an example in which each memory block outputs the image data corresponding to one subpixel by time division (dot-sequentially). Note that the invention is not limited thereto. Each memory block may output the image data corresponding to a plurality of subpixels by time division. FIG. 16 shows a configuration example of the pre-latch circuit LTA1, the post-latch circuit LTB1, and the data driver block DB1 in this case. In FIG. 16, 16-bit (=k-bit) subpixel image data corresponding to two subpixels is output from the memory block MB1. The 16-bit subpixel image data is sequentially latched by the flip-flop circuits FFA10 to FFA15. The 16-bit subpixel image data is then latched by the flip-flop circuits FFB10 to FFB15 in the subsequent stage.

In FIG. 16, each of the sub-driver blocks SDB0 to SDB5 outputs the data signals corresponding to two pixels based on the subpixel image data output from the memory block MB1. Specifically, the sub-driver block SDB0 outputs R, G, and B data signals DSR0, DSG0, DSB0, DSR1, DSG1, and DSB1 corresponding to two pixels. Likewise, the sub-driver block SDB1 outputs R, G, and B data signals DSR2, DSG2, DSB2, DSR3, DSG3, and DSB3 corresponding to two pixels. The above description also applies to the sub-driver blocks SDB2 to SDB5.

According to this configuration, the speed of data transfer from the memory block to the pre-latch circuit can be increased. Therefore, the sample operation and the hold operation of the data driver block can be provided with a sufficient time margin.

8. Data Driver

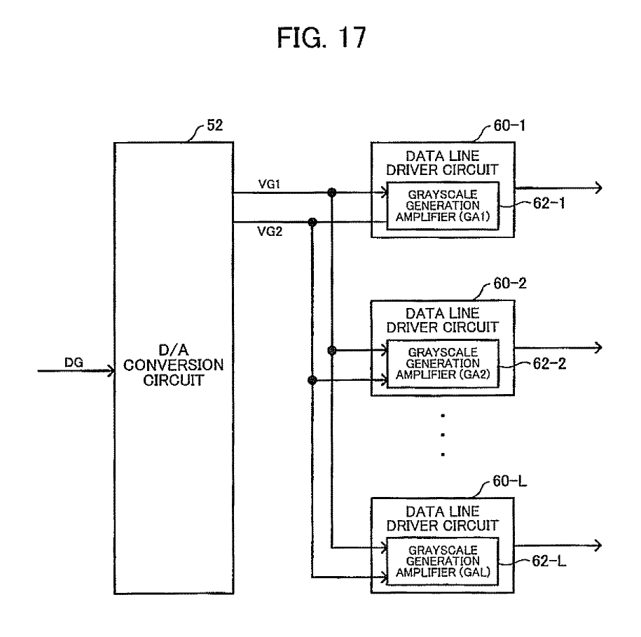

A detailed configuration example of the data driver is described below with reference to FIG. 17. FIG. 17 shows a configuration example of each of the sub-driver blocks SDB0 to SDB5 of the data driver described with reference to FIGS. 3, 14, 16, and the like. Each sub-driver block includes a D/A conversion circuit 52 and data line driver circuits 60-1 to 60-L. In FIG. 17, the D/A conversion circuit 52 is shared by the data line driver circuits 60-1 to 60-L (first to Lth data line driver circuits). Note that the data line driver circuit and the like may be provided corresponding to each data line of the electro-optical panel, or the data line driver circuit may drive a plurality of data lines by time division. Part or the entirety of the data driver (integrated circuit device) may be integrally formed on the electro-optical panel.

The D/A conversion circuit 52 (voltage generation circuit) receives grayscale data DG (image data or display data) from the memory 20 shown in FIG. 1, for example. The D/A conversion circuit 52 outputs a first grayscale voltage VG1 and a second grayscale voltage VG2 corresponding to the grayscale data DG.

Specifically, the D/A conversion circuit 52 receives the grayscale data, and outputs the first grayscale voltage VG1 and the second grayscale voltage VG2 corresponding to the grayscale data by time division in each of the first to Lth sample periods.

The data line driver circuits 60-1 to 60-L respectively include grayscale generation amplifiers 62-1 to 62-L (GA1 to GAL). The grayscale generation amplifiers 62-1 to 62-L sample the first grayscale voltage VG1 and the second grayscale voltage VG2 output from the D/A conversion circuit 52 in each of the first to Lth sample periods, and generate a grayscale voltage between the first grayscale voltage VG1 and the second grayscale voltage VG2.

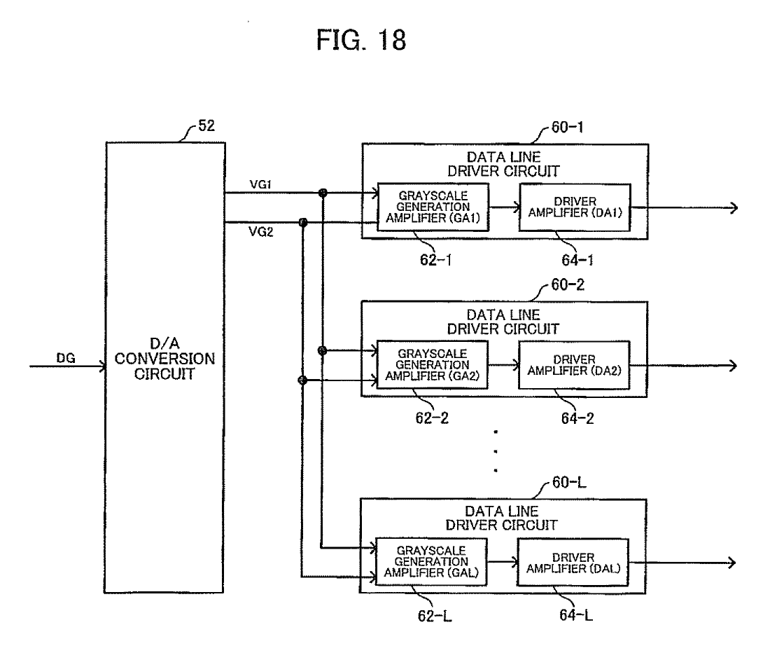

FIG. 18 shows a second configuration example of the data driver (sub-driver block). In FIG. 18, the data line driver circuits 60-1 to 60-L further include driver amplifiers 64-1 to 64-L (first to Lth driver amplifiers) provided in the subsequent stage of the grayscale generation amplifiers 62-1 to 62-L, respectively.

The driver amplifiers 64-1 to 64-L (DA1 to DAL) included in the data line driver circuits 60-1 to 60-L respectively sample the output voltages from the grayscale generation amplifiers 62-1 to 62-L in a driver amplifier sample period after the first to Lth sample periods. The driver amplifiers 64-1 to 64-L output the sampled output voltages in a driver amplifier hold period after the driver amplifier sample period.

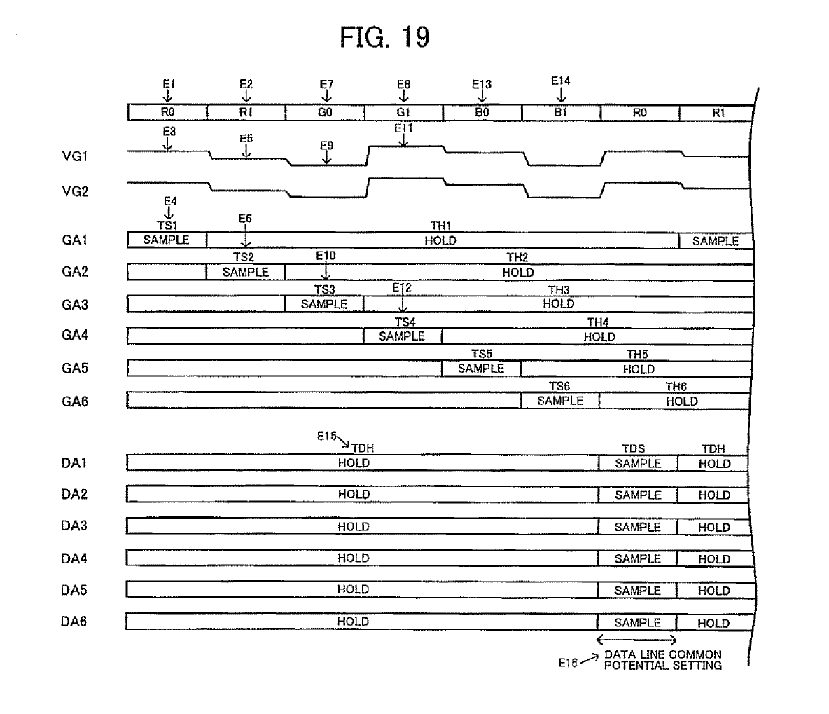

FIG. 19 shows a signal waveform example when the D/A conversion circuit 52 is shared by six data line driver circuits GA1 to GA6. The data line driver circuits GA1 to GA6 perform a sample operation in sample periods TS1 to TS6 (first to Lth sample periods), and perform a hold operation in hold periods TH1 to TH6 (first to Lth hold periods) after the sample periods TS1 to TS6, respectively.

The driver amplifiers DA1 to DA6 perform a sample operation in a driver amplifier sample period TDS after the sample periods TS1 to TS6, and perform a hold operation in a driver amplifier hold period TDH after the driver amplifier sample period TDS.

According to the configuration shown in FIGS. 17 and 18, it suffices to provide one D/A conversion circuit 52 corresponding to the data line driver circuits 60-1 to 60-L instead of providing the D/A conversion circuit corresponding to each data line driver circuit. Therefore, the area occupied by the D/A conversion circuit 52 in the integrated circuit device can be reduced so that the size of the integrated circuit device can be reduced.

Even if the D/A conversion circuit 52 outputs the first grayscale voltage VG1 and the second grayscale voltage VG2 by time division, a voltage can be appropriately sampled in each of the first to Lth sample periods by utilizing the sample function of the grayscale generation amplifiers 62-1 to 62-L.

When using the D/A conversion circuit 52 by time division, the total time of the sample periods TS1 to TS6 increases, as shown in FIG. 19. Therefore, the hold period TH6 of the grayscale generation amplifier GA6 decreases so that the data line drive time becomes insufficient, for example.

However, when the driver amplifiers DA1 to DA6 are provided in the subsequent stage of the grayscale generation amplifiers GA1 to GA6 (see FIG. 18), the driver amplifiers DA1 to DA6 are set in a hold operation mode in the sample periods TS1 to TS6 (see E15 in FIG. 19) so that the data lines can be driven. Therefore, since the data line drive time can be increased, a highly accurate voltage can be supplied to the data line.

A data driver normally performs a DAC drive operation that directly drives the data line using a D/A conversion circuit in the latter half of a drive period in order to increase the accuracy of the voltage supplied to the data line. Therefore, since it is necessary to provide a D/A conversion circuit having an identical configuration corresponding to each data line, the size of the integrated circuit device increases due to an increase in the layout area of the D/A conversion circuits.

On the other hand, an offset-free state can be implemented by forming the grayscale generation amplifier and the driver amplifier having a sample-hold function using a flip-around sample-hold circuit, for example. Therefore, since a highly accurate voltage can be supplied to the data line by minimizing a variation in the voltage output to the data line, the above-mentioned DAC drive operation becomes unnecessary. This makes it unnecessary to provide a D/A conversion circuit having an identical configuration corresponding to each data line. Therefore, one D/A conversion circuit can be shared by a plurality of data line driver circuits, as shown in FIGS. 17 and 18. As a result, the accuracy of the voltage supplied to the data line can be increased while reducing the area of the data driver.

The configuration shown in FIGS. 17 and 18 also has an advantage in that a grayscale voltage line can be utilized for R (red), G (green), and B (blue) by time division.

For example, suppose that a data transfer bus (grayscale data bus) that connects the memory 20 and the data driver 50 shown in FIG. 1 is a 16-bit bus. Suppose that the number of bits of each of R, G, and B subpixels is 8 bits, and the number of bits of the pixel formed by the R, G, and B subpixels is 24 (=8×3) bits.

In this case, the 8-bit subpixel image data R0 (grayscale data) corresponding to the first pixel and the 8-bit subpixel image data R1 (grayscale data) corresponding to the second pixel adjacent to the first pixel are transferred from each memory block to each data driver block through the 16-bit data transfer bus (grayscale data bus) described with reference to FIG. 10 (E1 and E2 in FIG. 19).

The D/A conversion circuit 52 outputs the first grayscale voltage VG1 and the second grayscale voltage VG2 corresponding to the 8-bit subpixel image data R0 (E3 in FIG. 19). The grayscale generation amplifier GA1 samples the first grayscale voltage VG1 and the second grayscale voltage VG2 in the sample period TS1, and generates a grayscale voltage between the first grayscale voltage VG1 and the second grayscale voltage VG2 (E4).

The D/A conversion circuit 52 outputs the first grayseale voltage VG1 and the second grayscale voltage VG2 corresponding to the 8-bit subpixel image data R1 (E5). The grayscale generation amplifier GA2 then samples the first grayscale voltage VG1 and the second grayscale voltage VG2 in the sample period TS2, and generates a grayscale voltage between the first grayscale voltage VG1 and the second grayscale voltage VG2 (E6).

As indicated by E7 and E8, the 8-bit subpixel image data G0 and the 8-bit subpixel image data G1 corresponding to the second pixel are transferred from each memory block to each data driver block through the 16-bit data transfer bus (grayscale data bus).

The D/A conversion circuit 52 outputs the first grayscale voltage VG1 and the second grayscale voltage VG2 corresponding to the 8-bit subpixel image data G0 (E9). The grayscale generation amplifier GA3 then samples the first grayscale voltage VG1 and the second grayscale voltage VG2 in the sample period TS3, and generates a grayscale voltage between the first grayscale voltage VG1 and the second grayscale voltage VG2 (E10).

The D/A conversion circuit 52 outputs the first grayscale voltage VG1 and the second grayscale voltage VG2 corresponding to the 8-bit subpixel image data G1 (E11). The grayscale generation amplifier GA4 then samples the first grayscale voltage VG1 and the second grayscale voltage VG2 in the sample period TS4, and generates a grayscale voltage between the first grayscale voltage VG1 and the second grayscale voltage VG2 (E12). The subpixel image data B0 and B1 is transferred at E13 and E14, and the above-described process is performed.

According to this configuration, it is unnecessary to separately provide R, G, and B grayscale voltage lines. Specifically, one grayscale voltage line can be used by time division for transferring the R, G, and B grayscale voltages. For example, the grayscale voltage line can be used for R at E1 and E2 in FIG. 19, can be used for G at E7 and E8, and can be used for B at E13 and E14.

For example, when sixty-four grayscale voltage lines are necessary for R, G, and B, respectively, 192 (=64×3) grayscale voltage lines must be provided when separately providing R, G, and B grayscale voltage lines.

According to this embodiment, since one grayscale voltage line is used for R, G, and B by time division, only sixty-four grayscale voltage lines are necessary. Therefore, the wiring area of the grayscale voltage lines can be significantly reduced so that the area of the integrated circuit device can be reduced.

Note that this embodiment employs a data line common potential setting method (equalization) in order to reduce power consumption. Specifically, the output lines of the driver amplifiers DA1 to DA6 are set at a common potential (e.g., common voltage VCOM) in the driver amplifier sample period TDS, as indicated by E16 in FIG. 19. For example, the output lines of the driver amplifiers DA1 to DA6 are set at the common voltage VCOM (i.e., common potential). Note that the common potential is not limited to the common voltage VCOM, but may be a GND potential or the like.

According to this configuration, since the data lines of the electro-optical panel are charged and discharged by recycling a charge stored in the electro-optical panel, power consumption can be further reduced.

9. Switch Circuit

Various modifications of the data driver according to this embodiment are described below. In the following description, the data line driver circuits 60-1 to 60-L, the grayscale generation amplifiers 62-1 to 62-L, and the driver amplifiers 64-1 to 64-L that share the D/A conversion circuit 52 are respectively referred to as a data line driver circuit 60, a grayscale generation amplifier 62, and a driver amplifier 64 for convenience of illustration.

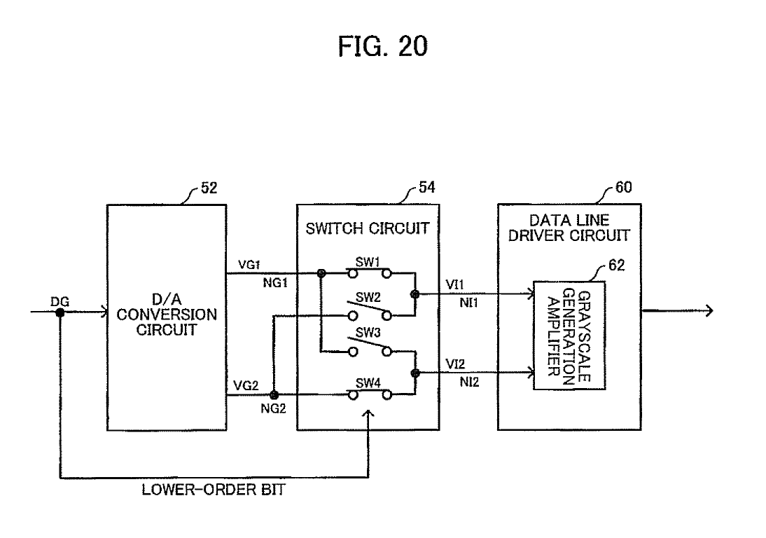

FIG. 20 shows a modification of the data driver according to this embodiment. A switch circuit 54 is additionally provided in this modification. In FIG. 20, the D/A conversion circuit 52 receives a plurality of grayscale voltages (e.g., V0 to V128 or V0 to V64) from the grayscale voltage generation circuit 110 shown in FIG. 1 through the grayscale voltage lines. The D/A conversion circuit 52 selects and outputs the first grayscale voltage VG1 and the second grayscale voltage VG2 corresponding to the grayscale data DG from the plurality of grayscale voltages. In this case, the first grayscale voltage VG1 and the second grayscale voltage VG2 output from the D/A conversion circuit 52 are consecutive (adjacent) grayscale voltages. Specifically, the first grayscale voltage VG1 and the second grayscale voltage VG2 are consecutive grayscale voltages (e.g., V0 and V1, V1 and V2, or V2 and V3) among a plurality of grayscale voltages (V0 to V128 or V0 to V64) input to the D/A conversion circuit 52 through the grayscale voltage lines.

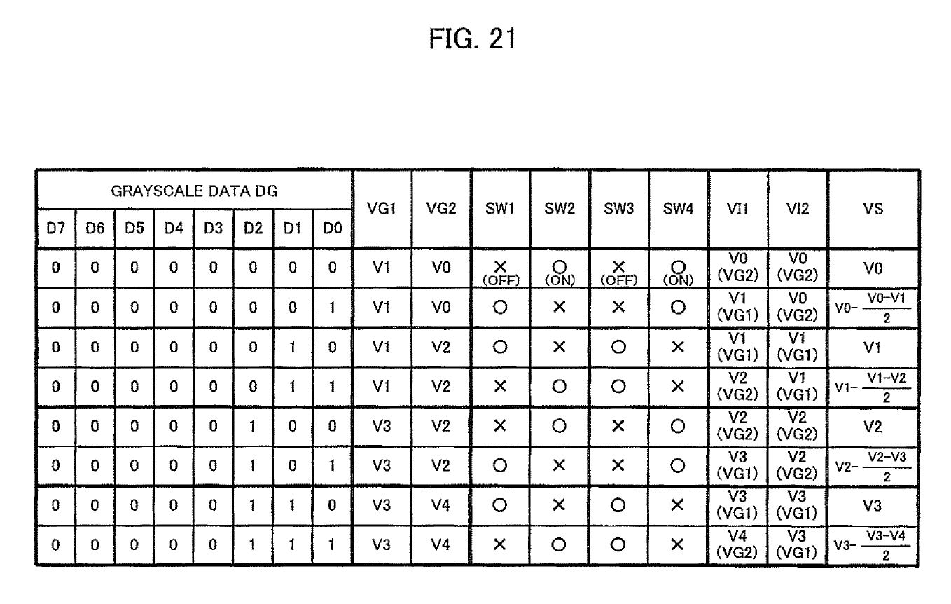

In FIG. 21, the grayscale data DG is 8-bit (256-grayscale) data (D7 to D0), for example. A plurality of grayscale voltages V0 to V128 are input to the D/A conversion circuit 52. The grayscale voltages V0 to V128 have a monotonically decreasing relationship (i.e., V0>V1>V2 . . . V127>V128). Note that the grayscale voltages V0 to V128 may have a monotonically increasing relationship (i.e., V0<V1<V2 . . . V127<V128).

The D/A conversion circuit 52 outputs the grayscale voltage V1 and the grayscale voltage V0 as the first grayscale voltage VG1 and the second grayscale voltage VG2 (i.e., VG1=V1 and VG2=V0), respectively, when the grayscale data DG (D7 to D0) is (00000000) or (00000001), and outputs the grayscale voltage V1 and the grayscale voltage V2 as the first grayscale voltage VG1 and the second grayscale voltage VG2 (i.e., VG1=V1 and VG2=V2), respectively, when the grayscale data DG (D7 to D0) is (00000010) or (00000011). The D/A conversion circuit 52 outputs the grayscale voltage V3 and the grayscale voltage V2 as the first grayscale voltage VG1 and the second grayscale voltage VG2 (i.e., VG1=V3 and VG2=V2), respectively, when the grayscale data DG (D7 to D0) is (00000100) or (00000101), and outputs the grayscale voltage V3 and the grayscale voltage V4 as the first grayscale voltage VG1 and the second grayscale voltage VG2 (i.e., VG1=V3 and VG2=V4), respectively, when the grayscale data DG (D7 to D0) is (00000110) or (00000111).

The D/A conversion circuit 52 thus outputs consecutive grayscale voltages corresponding to the grayscale data DG among the grayscale voltages V0 to V128 input from the grayscale voltage generation circuit 110 as the first grayscale voltage VG1 and the second grayscale voltage VG2. Although FIGS. 20 and 21 illustrate an example in which the D/A conversion circuit 52 generates two grayscale voltages (i.e., first grayscale voltage VG1 and second grayscale voltage VG2), the types (number) of grayscale voltages output from the D/A conversion circuit 52 are not limited thereto.

The data line driver circuit 60 (data line driver circuits 60-1 to 60-L) is a circuit that drives the data line of the electro-optical panel 400, and includes a grayscale generation amplifier 62 (grayseale generation amplifiers 62-1 to 62-L). The grayscale generation amplifier 62 (grayscale generation sample-hold circuit) generates and outputs a grayscale voltage between the first grayscale voltage VG1 and the second grayscale voltage VG2.

In FIG. 21, when the grayscale data DG is (00000001), the grayscale generation amplifier 62 generates (samples) and outputs the voltage (V0−(V0−V1)/2) between the first grayscale voltage VG1 (=V1) and the second grayscale voltage VG2 (=V0) as a grayscale voltage VS. When the grayscale data DG is (00000000), the grayscale generation amplifier 62 outputs the grayscale voltage V0 (−VG2) as the grayscale voltage VS. When the grayscale data DG is (00000011), the grayscale generation amplifier 62 generates and outputs the voltage (V1−(V1−V2)/2) between the first grayscale voltage VG1 (=V1) and the second grayscale voltage VG2 (=V2) as the grayscale voltage VS. When the grayscale data DG is (00000010), the grayscale generation amplifier 62 outputs the grayscale voltage V1 (=VG1) as the grayscale voltage VS.

The switch circuit 54 is provided between the D/A conversion circuit 52 and the data line driver circuit 60. The switch circuit 54 may be an element of the D/A conversion circuit 52 or the data line driver circuit 60.

The switch circuit 54 includes a plurality of switch elements. In FIG. 20, the switch circuit 54 includes a first switch element SW1 to a fourth switch element SW4, for example. Note that the number of switch elements is not limited to four, but may be eight, sixteen, or the like. The switch elements SW1 to SW4 may be formed by CMOS transistors. Specifically, the switch elements SW1 to SW4 may be formed by transfer gates including a P-type transistor and an N-type transistor. These transistors are turned ON/OFF based on switch control signals output from a switch control signal generation circuit (not shown).

The switch element SW1 is provided between a first voltage output node NG1 (i.e., output node of the first grayscale voltage VG1) of the D/A conversion circuit 52 and a first input node NI1 of the grayscale generation amplifier 62 (data line driver circuit 60). The switch element SW2 is provided between a second voltage output node NG2 (i.e., output node of the second grayscale voltage VG2) of the D/A conversion circuit 52 and the input node NI1 of the grayscale generation amplifier 62. The switch element SW1 and the switch element SW2 are exclusively turned ON/OFF. As shown in FIG. 21, the switch element SW1 is turned OFF and the switch element SW2 is turned ON when the grayscale data DG is (00000000), and the switch element SW1 is turned ON and the switch element SW2 is turned OFF when the grayscale data DG is (00000001), for example.

The switch element SW3 is provided between the voltage output node NG1 of the D/A conversion circuit 52 and an input node NI2 of the grayscale generation amplifier 62. The switch element SW4 is provided between the voltage output node NG2 of the D/A conversion circuit 52 and the input node NI2 of the grayscale generation amplifier 62. The switch element SW3 and the switch element SW4 are exclusively turned ON/OFF. For example, the switch element SW3 is turned OFF and the switch element SW4 is turned ON when the grayscale data DG is (00000001), and the switch element SW3 is turned ON and the switch element SW4 is turned OFF when the grayscale data DG is (00000010).

As shown in FIG. 21, when the grayscale data DG is (00000000), the D/A conversion circuit 52 outputs the grayscale voltage V1 and the grayscale voltage V0 as the first grayscale voltage VG1 and the second grayscale voltage VG2, respectively. The switch elements SW1, SW2, SW3, and SW4 of the switch circuit 54 are turned OFF, ON, OFF, and ON, respectively. Therefore, a grayscale voltage VI1 (=VG2=V0) and a grayscale voltage VI2 (=VG2=V0) are respectively input to the input node NI1 and the input node NI2 of the grayscale generation amplifier 62. The grayscale s generation amplifier 62 thus outputs the grayscale voltage V0 as the grayscale voltage VS (sample voltage).

When the grayscale data DG is (00000001), the switch elements SW1, SW2, SW3, and SW4 are turned ON, OFF, OFF, and ON, respectively. Therefore, the grayscale voltage VI1 (=VG1=V1) and the grayscale voltage VI2 (=VG2=V0) are respectively input to the input node NI1 and the input node NI2 of the grayscale generation amplifier 62 so that the grayscale generation amplifier 62 outputs the voltage (V0−(V0−V1)/2) as the grayscale voltage VS. Specifically, the grayscale generation amplifier 62 outputs the grayscale voltage corresponding to the grayscale data DG (=(00000001)).

When the grayscale data DG is (00000010), the D/A conversion circuit 52 outputs the grayscale voltage V1 and the grayscale voltage V2 as the first grayscale voltage VG1 and the second grayscale voltage VG2, respectively. The switch elements SW1, SW2, SW3, and SW4 are turned ON, OFF, ON, and OFF, respectively. Therefore, the grayscale voltage VI1 (=VG1=V1) and the grayscale voltage VI2 (=VG1−V1) are respectively input to the input node NI1 and the input node NI2 of the grayscale generation amplifier 62 so that the grayscale generation amplifier 62 outputs the grayscale voltage V1 as the grayscale voltage VS.

When the grayscale data DG is (00000011), the switch elements SW1, SW2, SW3, and SW4 are turned OFF, ON, ON, and OFF, respectively. Therefore, the grayscale voltage VI1 (=VG2=V2) and the grayscale voltage VI2 (=VG1=V1) are respectively input to the input node NI1 and the input node NI2 of the grayscale generation amplifier 62 so that the grayscale generation amplifier 62 outputs the voltage (V1−(V1−V2)/2) as the grayscale voltage VS. Specifically, the grayscale generation amplifier 62 outputs the grayscale voltage corresponding to the grayscale data DG (=(00000011)).

As shown in FIG. 21, the switch elements SW1 to SW4 are turned ON/OFF based on the lower-order bits of the grayscale data DG. Specifically, the switch elements SW1 to SW4 are turned ON/OFF based on switch control signals that are generated based on the lower-order bits of the grayscale data DG. For example, when the lower-order bits D1 and D0 of the grayscale data DG are (00), the switch elements SW1, SW2, SW3, and SW4 are turned OFF, ON, OFF, and ON, respectively, as shown in FIG. 21. When the lower-order bits D1 and D0 of the grayscale data DG are (01), the switch elements SW1, SW2, SW3, and SW4 are turned ON, OFF, OFF, and ON, respectively. When the lower-order bits D1 and D0 of the grayscale data DG are (10), the switch elements SW1, SW2, SW3, and SW4 are turned ON, OFF, ON, and OFF, respectively. When the lower-order bits D1 and D0 of the grayscale data DG are (11), the switch elements SW1, SW2, SW3, and SW4 are turned OFF, ON, ON, and OFF, respectively.

Since the above-described data driver can generate the grayscale voltage using the grayscale generation amplifier 62, the number (types) of grayscale voltages generated by the grayscale voltage generation circuit 110 shown in FIG. 1 can be reduced. This makes it possible to reduce the number of grayscale voltage lines while reducing the circuit scale of the D/A conversion circuit 52.

For example, when the number of bits of the grayscale data DG is eight (i.e., the number of grayscales is 2⁸ (=256)), the grayscale voltage generation circuit 110 must generate 256 grayscale voltages when using a related-art method. Therefore, the D/A conversion circuit 52 must include selectors that select the grayscale voltages corresponding to the grayscale data DG from the 256 grayscale voltages. This increases the size of the grayscale voltage generation circuit 110 and the D/A conversion circuit 52. Moreover, since 256 grayscale voltage lines are required, the wiring area increases.

On the other hand, since the data driver shown in FIG. 20 generates the grayscale voltage using the grayscale generation amplifier 62, it suffices that the grayscale voltage generation circuit 110 generate 128 grayscale voltages, for example. Therefore, it suffices that the D/A conversion circuit 52 include selectors that select voltages from the 128 grayscale voltages. Accordingly, the circuit scale can be significantly reduced as compared with the related-art method. Moreover, since the number of grayscale voltage lines can be reduced to 128, the wiring area can be significantly reduced. Note that 129 (=128+1) grayscale voltage lines are required in the above-described case since the grayscale generation amplifier 62 generates a voltage by dividing the voltage between the first grayscale voltage VG1 and the second grayscale voltage VG2.

According to the data driver shown in FIG. 20, the grayscale generation amplifier 62 has a sample-hold function. Therefore, a voltage that varies to only a small extent can be supplied to the data line without performing a DAC drive operation that directly drives the data line using the D/A conversion circuit 52. Specifically, an accurate voltage can be supplied to the data line by a relatively small and simple circuit configuration. Since the grayscale generation amplifier 62 has a sample-hold function, a plurality of data line driver circuits 60 can share one D/A conversion circuit 52. Therefore, the circuit scale can be further reduced.

According to the data driver shown in FIG. 20, the switch circuit 54 is provided between the D/A conversion circuit 52 and the data line driver circuit 60. Therefore, the input voltages (VI1, VI2)=(V0, V0), (V1, V0), (V1, V1), (V2, V1), . . . can be input to the grayscale generation amplifier 62 (see FIG. 21) based on the first grayscale voltage VG1 and the second grayscale voltage VG2 output from the D/A conversion circuit 52, for example. As a result, the grayscale generation amplifier 62 can output a grayscale voltage that decreases monotonically (or increases monotonically) (e.g., VS=V0, V0−(V0−V1)/2, V1, V1−(V1−V2)/2, V2, . . . ) so that an appropriate grayscale voltage can be output by a simple circuit configuration.

10. Flip-Around Sample-Hold Circuit

The grayscale generation amplifier 62 may be formed by a flip-around sample-hold circuit. The term “flip-around sample-hold circuit” refers to a circuit that samples a charge corresponding to an input voltage using a sampling capacitor in a sample period, and performs a flip-around operation of the sampling capacitor in a hold period to output a voltage corresponding to the stored charge to its output node, for example.

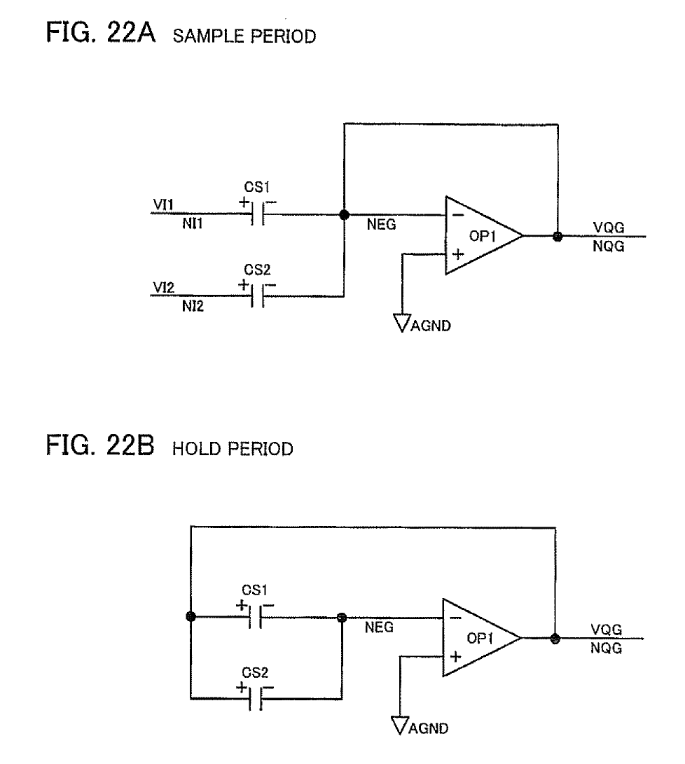

The flip-around sample-hold circuit is described in detail below with reference to FIGS. 22A and 22B.

In FIGS. 22A and 22B, the grayscale generation amplifier 62 formed by a flip-around sample-hold circuit includes an operational amplifier OP1 and first and second sampling capacitors CS1 and CS2 (a plurality of sampling capacitors), for example.

The sampling capacitor CS1 is provided between an inverting input terminal (first input terminal) of the operational amplifier OP1 and the input node NI1 of the grayscale generation amplifier 62. As shown in FIG. 22A, the capacitor CS1 stores a charge corresponding to the input voltage VI1 at the input node NI1 in the sample period.

The sampling capacitor CS2 is provided between the inverting input terminal of the operational amplifier OP1 and the input node NI2 of the grayscale generation amplifier 62. The capacitor CS2 stores a charge corresponding to the input voltage VI2 at the input node NI2 in the sample period.

As shown in FIG. 22A, the output from the operational amplifier OP1 is fed back to a node NEG of the inverting input terminal of the operational amplifier OP1 in the sample period. A non-inverting input terminal (second input terminal) of the operational amplifier OP1 is set at the analog reference power supply voltage AGND. Therefore, the node NEG connected to one end of the capacitors CS1 and CS2 is set at the reference power supply voltage AGND due to a virtual short-circuit function of the operational amplifier OP1. As a result, charges corresponding to the input voltages VI1 and VI2 are respectively stored in the capacitors CS1 and CS2.

The analog reference power supply voltage AGND is set at (adjusted to) a voltage (intermediate voltage) between the high-potential-side power supply voltage VDDHS and the low-potential-side power supply voltage VSS of the operational amplifier OP1. Specifically, the analog reference power supply voltage AGND is set at VSS+(VDDHS+VSS)/ML. When VSS=0 and ML=2, the analog reference power supply voltage AGND is (VDDHS+VSS)/2. Note that the coefficient ML need not necessarily be two (ML=2). The coefficient ML may be appropriately adjusted corresponding to the display characteristics and the like. It suffices that the coefficient ML be larger than one (ML>1).

The power supply voltage VDDHS is a voltage supplied to the source of a high-potential-side P-type transistor included in the operational amplifier OP1, and the power supply voltage VSS is a voltage supplied to the source of a low-potential-side N-type transistor included in the operational amplifier OP1, for example. The operational amplifier OP1 operates using the power supply voltages VDDHS and VSS as operating power supply voltages.

In the hold period, the grayscale generation amplifier 62 outputs an output voltage VQG (=VS) corresponding to the charges stored in the sampling capacitors CS1 and CS2 in the sample period to an output node NQG, as shown in FIG. 22B. Specifically, the grayscale generation amplifier 62 outputs the output voltage VQG corresponding to the charges stored in the sampling capacitors CS1 and CS2 by performing a flip-around operation that connects the other end of the capacitors CS1 and CS2 connected to the node NEG at one end to an output terminal of the operational amplifier OP1.

An offset-free state can be implemented by forming the grayscale generation amplifier 62 using the above-described flip-around sample-hold circuit.

For example, an offset voltage generated between the inverting input terminal and the non-inverting input terminal of the operational amplifier OP1 is referred to as VOF, the analog reference power supply voltage AGND is set at 0 V for convenience, the input voltages in the sample period are set at VI1=VI2=VI, and the parallel capacitance of the capacitors CS1 and CS2 (connected in parallel) is referred to as CS. In this case, a charge Q stored in the sample period is expressed by the following equation.

Q=(VI−VOF)×CS (1)

When the voltage of the node NEG in the hold period is referred to as VX and the output voltage is referred to as VQG, a charge Q′ stored in the hold period is expressed by the following equation.

Q′=(VQG−VX)×CS (2)

When the amplification factor of the operational amplifier OP1 is referred to as A, the output voltage VQG is expressed by the following equation.

VQG=−A×(VX−VOF) (3)

Since Q=Q′ is satisfied according to the principle of charge conservation, the following equation is satisfied.

(VI−VOF)×CS=(VQG−VX)×CS (4)

Therefore, the following equation is satisfied from the equations (3) and (4).

VQG=VI−VOF+VX=VI−VOF+VOF−VQG/A

Therefore, the output voltage VQG of the grayscale generation amplifier 62 is expressed by the following equation.

VQG={1/(1+1/A)}×VI (5)

As is clear from the equation (5), since the output voltage VQG of the grayscale generation amplifier 62 is independent of the offset voltage VOF and an offset can be canceled, an offset-free state can be implemented.

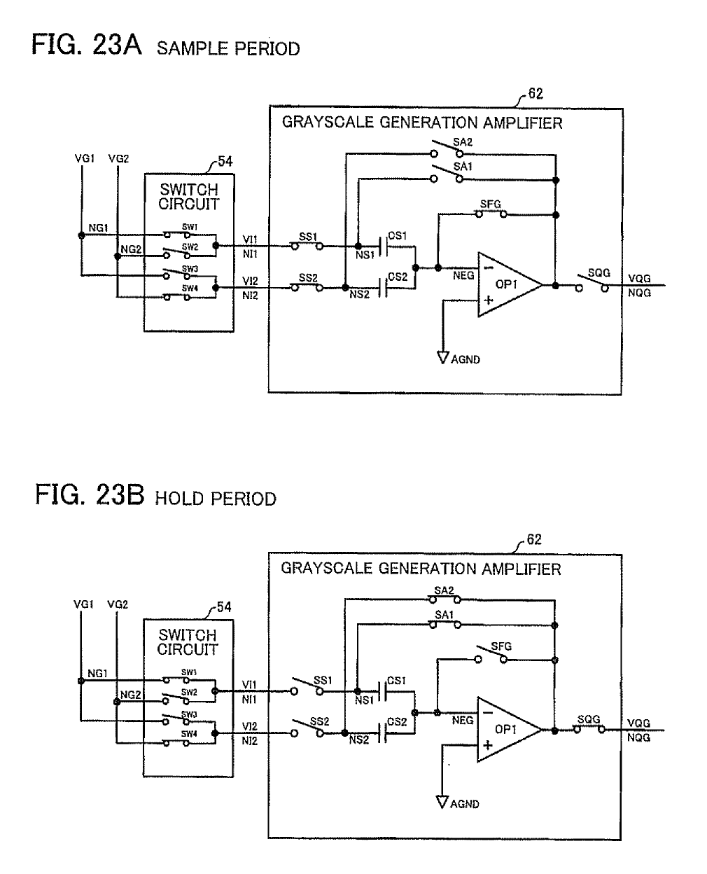

FIGS. 23A and 23B show a specific configuration example of the grayscale generation amplifier 62 using the flip-around sample-hold circuit. The grayscale generation amplifier 62 shown in FIGS. 23A and 23B includes the operational amplifier OP1, first and second sampling switch elements SS1 and SS2, the first and second sampling capacitors CS1 and CS2, a feedback switch element SFQ and first and second flip-around switch elements SA1 and SA2. The grayscale generation amplifier 62 also includes an output switch element SQG. Note that modifications may be made such as omitting some of the elements or adding other elements. The switch elements SS1, SS2, SA1, SA2, SFG, and SQG may be formed by CMOS transistors (e.g., transfer gate), for example.

The non-inverting input terminal (second input terminal) of the operational amplifier OP1 is set at the analog reference power supply voltage AGND. The sampling switch element SS1 and the sampling capacitor CS1 are provided between the input node NI1 of the grayscale generation amplifier 62 and the inverting input terminal (first input terminal) of the operational amplifier OP. The sampling switch element SS2 and the sampling capacitor CS2 are provided between the input node NI2 of the grayscale generation amplifier 62 and the inverting input terminal of the operational amplifier OP1.

The feedback switch element SFG is provided between the output terminal and the inverting input terminal of the operational amplifier OP1.

The flip-around switch element SA1 is provided between a first connection node NS1 situated between the switch element SS1 and the capacitor CS1, and the output terminal of the operational amplifier OP1. The flip-around switch element SA2 is provided between a second connection node NS2 situated between the switch element SS2 and the capacitor CS2 and the output terminal of the operational amplifier OP1.

In the sample period, the sampling switch elements SS1 and SS2 and the feedback switch element SFG are turned ON, and the flip-around switch elements SA1 and SA2 are turned OFF, as shown in FIG. 23A.

In the hold period, the sampling switch elements SS1 and SS2 and the feedback switch element SFG are turned OFF, and the flip-around switch elements SA1 and SA2 are turned ON, as shown in FIG. 23B.

The output switch element SQG is provided between the output terminal of the operational amplifier OP1 and the output node NQG of the grayscale generation amplifier 62. In the sample period, the output switch element SQG is turned OFF, as shown in FIG. 23A. This causes the output of the grayscale generation amplifier 62 to be set in a high impedance state so that a situation in which an indefinite voltage in the sample period is transmitted to the subsequent stage can be prevented.

In the hold period, the output switch element SQG is turned ON, as shown in FIG. 23B. Therefore, the voltage VQG (i.e., the grayscale voltage generated in the sample period) can be output.

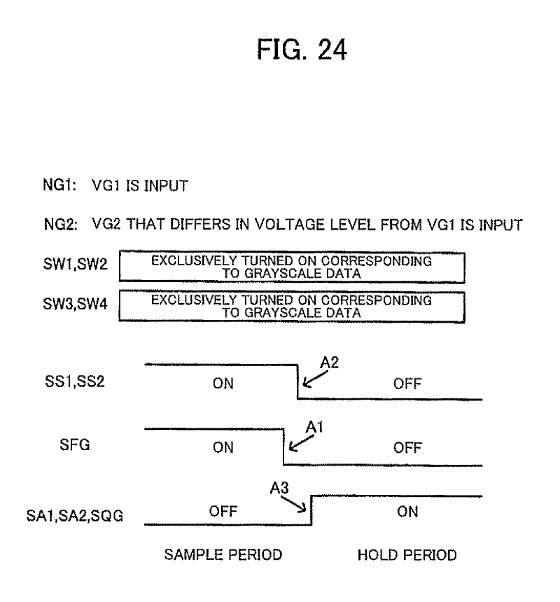

The operation of the circuit shown in FIGS. 23A and 23B is described below with reference to FIG. 24. The first grayscale voltage VG1 output from the D/A conversion circuit 52 is input to the node NG1, and the second grayscale voltage VG2 that differs in voltage level from the first grayscale voltage VG1 is input to the node NG2.

The switch element SW1 or SW2 of the switch circuit 54 is exclusively turned ON corresponding to the grayscale data DG. The switch element SW3 or SW4 is exclusively turned ON corresponding to the grayscale data DG.

In the sample period, switch control signals input to the sampling switch elements SS1 and SS2 and the feedback switch element SFG are activated (H level) so that the sampling switch elements SS1 and SS2 and the feedback switch element SFG are turned ON. On the other hand, switch control signals input to the flip-around switch elements SA1 and SA2 and the output switch element SQG are inactivated (L level) so that the flip-around switch elements SA1 and SA2 and the output switch element SQG are turned OFF.

In the hold period, the switch control signals input to the sampling switch elements SS1 and SS2 and the feedback switch element SFG are inactivated so that the sampling switch elements SS1 and SS2 and the feedback switch element SFG are turned OFF. On the other hand, the switch control signals input to the flip-around switch elements SA1 and SA2 and the output switch element SQG are activated so that the flip-around switch elements SA1 and SA2 and the output switch element SQG are turned ON.

The sampling switch elements SS1 and SS2 are turned OFF after the feedback switch element SFG has been turned OFF, as indicated by A1 and A2 in FIG. 24. This minimizes an adverse effect of charge injection. The flip-around switch elements SA1 and SA and the output switch element SQG are turned ON after the sampling switch elements SS1 and SS2 have been turned OFF, as indicated by A3.

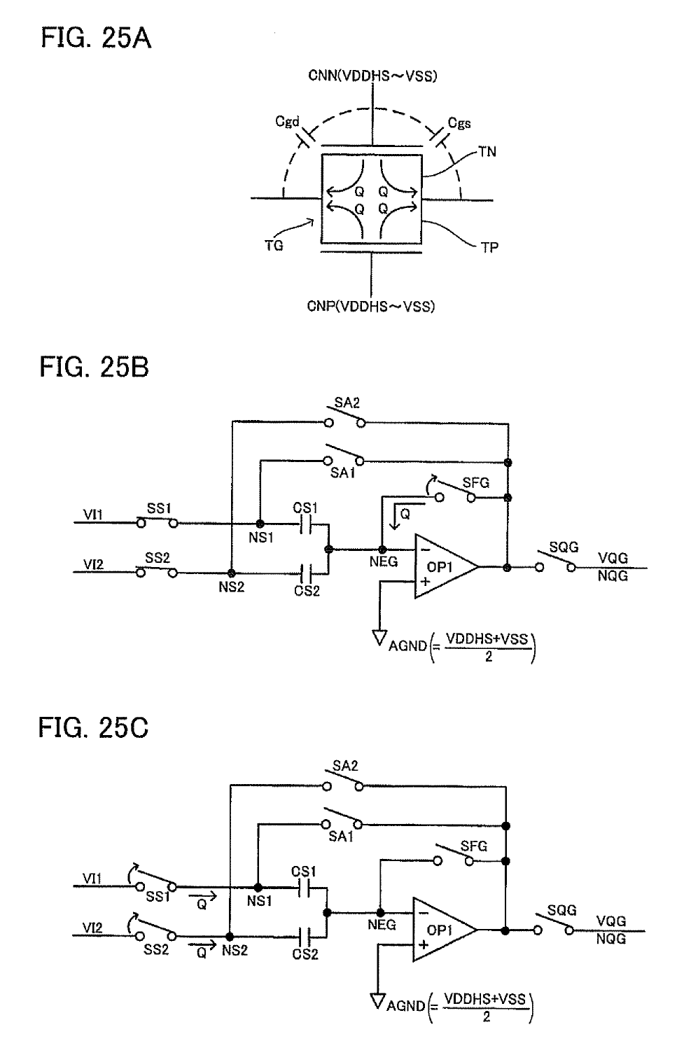

FIG. 25A shows an example of a transfer gate TG used as the switch element. Switch control signals CNN and CNP are respectively input to the gates of an N-type transistor TN and a P-type transistor TP that form the transfer gate TG. When the transfer gate TG is turned OFF, clock feedthrough occurs due to a gate-drain parasitic capacitor Cgd and a gate-source parasitic capacitor Cgs. When the transfer gate TG is turned OFF, a charge in the channel flows into the drain or the source (i.e., charge injection occurs).

According to this embodiment, since the sampling switch elements SS1 and SS2 are turned OFF (see FIG. 25C) after the feedback switch element SFG has been turned OFF (see FIG. 25B), an adverse effect of charge injection or clock feedthrough can be reduced.

Specifically, if the switch element SFG is turned OFF when the switch elements SS1 and SS2 are set in an ON state (see FIG. 25B), an adverse effect of charge injection or clock feedthrough via the switch element SFG occurs. However, the switch element SFG has been turned OFF (i.e., the node NEG has been set in a high impedance state) when the switch elements SS1 and SS2 are turned OFF (see FIG. 25C). Therefore, an adverse effect of charge injection or clock feedthrough via the switch elements SS1 and SS2 does not occur. As a result, an adverse effect of charge injection or clock feedthrough can be reduced.

The switch control signals CNN and CNP having an amplitude between VDDHS and VSS are input to the gates of the transistors TN and TP of the transfer gate TG shown in FIG. 25A. Therefore, when the potential of the drain or the source of the transfer gate TG is set at VSS or VDDHS, an imbalance occurs between the amount of charge from the N-type transistor TN and the amount of charge from the P-type transistor TP. As a result, a charge due to charge injection remains without being canceled.

According to this embodiment, the non-inverting input terminal of the operational amplifier OP1 is set at the analog reference power supply voltage AGND (i.e., the intermediate voltage between the voltage VDDHS and the voltage VSS) immediately before the switch element SFG is turned OFF (see FIG. 25B), and the potential of the node NEG is set at the analog reference power supply voltage AGND (=(VDDHS+VSS)/2) due to the virtual short-circuit function of the operational amplifier OP1. Therefore, since the source and the drain of the switch element SFG are set at the analog reference power supply voltage AGND (i.e. independent of the input grayscale voltage) immediately before the switch element SFG is turned OFF and an imbalance between the amount of charge from the N-type transistor and the amount of charge from the P-type transistor can be reduced, an adverse effect of charge injection that occurs when the switch element SFG is turned OFF can be minimized.

11. Electronic Instrument

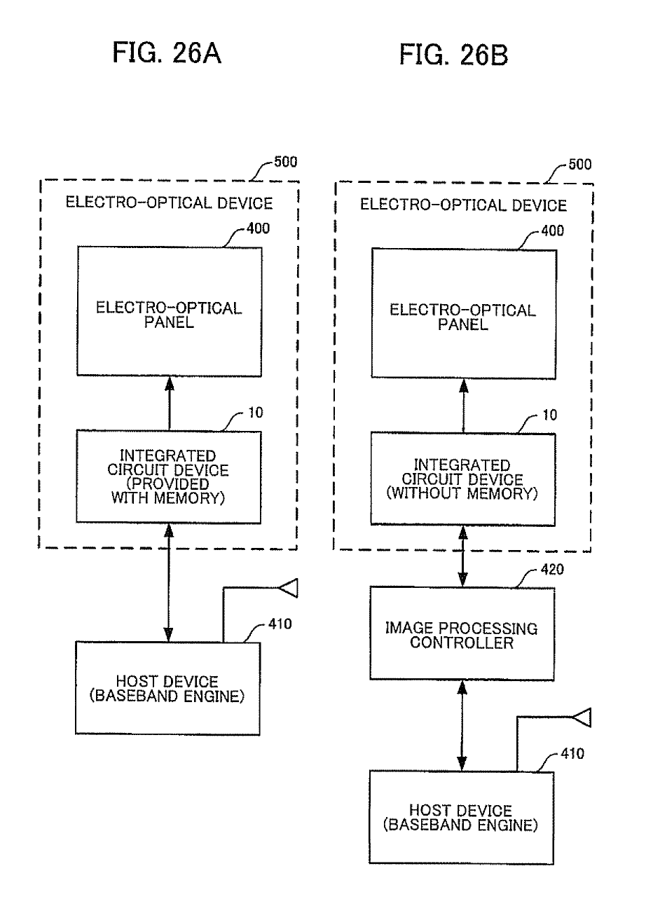

FIGS. 26A and 26B show configuration examples of an electronic instrument and an electro-optical device 500 including the integrated circuit device 10 according to the above embodiment. Note that various modifications may be made such as omitting some of the elements shown in FIGS. 26A and 26B or adding other elements (e.g., camera, operation section, or power supply). The electronic instrument according to this embodiment is not limited to a portable telephone, but may be a digital camera, a PDA, an electronic notebook, an electronic dictionary, a television, a projector, a portable information terminal, or the like.

In FIGS. 26A and 26B, a host device 410 is an MPU, a baseband engine, or the like. The host device 410 controls the integrated circuit device 10 (i.e., display driver). The host device 410 may also perform a process of an application engine or a baseband engine, or a process (e.g., compression, decompression, or sizing) of a graphic engine. An image processing controller 420 shown in FIG. 26B performs a process of a graphic engine, such as compression, decompression, or sizing, instead of the host device 410.

In FIG. 26A, the integrated circuit device 10 may include a memory. In this case, the integrated circuit device 10 writes image data output from the host device 410 into the built-in memory, reads the image data from the built-in memory, and drives the electro-optical panel. In FIG. 26B, the integrated circuit device 10 may not include a memory. In this case, image data output from the host device 410 is written into a built-in memory of the image processing controller 420. The integrated circuit device 10 drives the electro-optical panel 400 under control of the image processing controller 420.

Although some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term (e.g., inverting input terminal and non-inverting input terminal) cited with a different term (e.g., first input terminal and second input terminal) having a broader meaning or the same meaning at least once in the specification and the drawings may be replaced by the different term in any place in the specification and the drawings. The configurations and the operations of the integrated circuit device, the electro-optical device, and the electronic instrument are not limited to those described in the above embodiments. Various modifications and variations may be made.

What is claimed is:

1. An integrated circuit device comprising:
first to Nth (N is an integer equal to or larger than two) data driver blocks that are disposed along a first direction and supply data signals to a plurality of data lines of an electro-optical device,
each of the first to Nth data driver blocks including first to Mth (M is an integer equal to or larger than two) sub-driver blocks, and
a Jth (J is an integer that satisfies 1≦J≦M) sub-driver block among the first to Mth sub-driver blocks including:
a D/A conversion circuit that receives image data and D/A-converts the image data; and
first to Lth (L is an integer equal to or larger than two) data line driver circuits that are disposed along the first direction in a second direction with respect to the D/A conversion circuit and share the D/A conversion circuit, the second direction being a direction that perpendicularly intersects the first direction.

2. The integrated circuit device as defined in claim 1, further comprising:
a plurality of repeater circuits, each of the plurality of repeater circuits being provided between adjacent sub-driver blocks among the first to Mth sub-driver blocks.

3. The integrated circuit device as defined in claim 2,
each of the plurality of repeater circuits including a bias repeater circuit that receives a reference bias signal and supplies a bias signal generated based on the reference bias signal to the first to Lth data line driver circuits included in a corresponding sub-driver block among the first to Mth sub-driver blocks.

4. The integrated circuit device as defined in claim 2,
each of the first to Lth data line driver circuits including:
an operational amplifier; and
at least one capacitor,
a capacitor area being provided in the second direction with respect to an operational amplifier area, the operational amplifier being disposed in the operational amplifier area, and the at least one capacitor being formed in the capacitor area.

5. The integrated circuit device as defined in claim 4,
a plurality of repeater circuit signal lines being provided in the capacitor area along the first direction.

6. The integrated circuit device as defined in claim 1, further comprising:
first to Nth memory blocks that are disposed along the first direction in a fourth direction with respect to the first to Nth data driver blocks and store the image data, the fourth direction being a direction opposite to the second direction,
a Jth memory block among the first to Nth memory blocks dot-sequentially reading subpixel image data and outputting the subpixel image data to a corresponding Jth data driver block among the first to Nth data driver blocks, the subpixel image data being image data corresponding to at least one subpixel; and
the Jth data driver block receiving the subpixel image data from the Jth memory block, and outputting data signals corresponding to the subpixel image data.

7. The integrated circuit device as defined in claim 6,
the Jth memory block and the Jth data driver block being disposed so that a center position of the Jth memory block is shifted in the first direction with respect to a center position of the Jth data driver block.

8. The integrated circuit device as defined in claim 6, further comprising:
first to Nth pre-latch circuits; and
first to Nth post-latch circuits,
a Jth pre-latch circuit among the first to Nth pre-latch circuits sequentially latching the subpixel image data output from the Jth memory block by time division; and
a Jth post-latch circuit among the first to Nth post-latch circuits line-sequentially reading and latching the subpixel image data after the Jth pre-latch circuit has latched the subpixel image data, and outputting the subpixel image data to the Jth data driver block.

9. The integrated circuit device as defined in claim 1,
the D/A conversion circuit receiving subpixel image data as the image data, and outputting grayscale voltages corresponding to the subpixel image data by time division in each of first to Lth sample periods; and
each of the first to Lth data line driver circuits sampling the grayscale voltages output from the D/A conversion circuit in each of the first to Lth sample periods.

10. The integrated circuit device as defined in claim 9,
the D/A conversion circuit outputting a first grayscale voltage and a second grayscale voltage corresponding to the subpixel image data by time division in each of the first to Lth sample periods; and
each of the first to Lth data line driver circuits including a grayscale generation amplifier that samples the first grayscale voltage and the second grayscale voltage output from the D/A conversion circuit in each of the first to Lth sample periods, and generates a grayscale voltage between the first grayscale voltage and the second grayscale voltage.

11. The integrated circuit device as defined in claim 10,
the grayscale generation amplifier being configured by a flip-around sample-hold circuit.

12. The integrated circuit device as defined in claim 11,
the grayscale generation amplifier including:
an operational amplifier;
a first sampling capacitor that is provided between a first input terminal of the operational amplifier and a first input node of the grayscale generation amplifier and stores a charge corresponding to an input voltage at the first input node in a sample period; and
a second sampling capacitor that is provided between the first input terminal of the operational amplifier and a second input node of the grayseale generation amplifier and stores a charge corresponding to an input voltage at the second input node in the sample period,
the grayscale generation amplifier outputting an output voltage in a hold period, the output voltage corresponding to charges stored in the first sampling capacitor and the second sampling capacitor in the sample period.

13. The integrated circuit device as defined in claim 11,
the grayscale generation amplifier including:
an operational amplifier, an analog reference power supply voltage being supplied to a second input terminal of the operational amplifier;
a first sampling switch element and a first sampling capacitor, the first sampling switch element and the first sampling capacitor being provided between a first input node of the grayscale generation amplifier and a first input terminal of the operational amplifier;
a second sampling switch element and a second sampling capacitor, the second sampling switch element and the second sampling capacitor being provided between a second input node of the grayscale generation amplifier and the first input terminal of the operational amplifier;
a feedback switch element provided between an output terminal and the first input terminal of the operational amplifier;
a first flip-around switch element provided between a first connection node and the output terminal of the operational amplifier, the first connection node being situated between the first sampling switch element and the first sampling capacitor; and
a second flip-around switch element provided between a second connection node and the output terminal of the operational amplifier, the second connection node being situated between the second sampling switch element and the second sampling capacitor.

14. The integrated circuit device as defined in claim 13,
the first sampling switch element, the second sampling switch element, and the feedback switch element being turned ON and the first flip-around switch element and the second flip-around switch element being turned OFF in the sample period; and
the first sampling switch element, the second sampling switch elements and the feedback switch element being turned OFF and the first flip-around switch element and the second flip-around switch element being turned ON in a hold period.

15. The integrated circuit device as defined in claim 14,
the first sampling switch element and the second sampling switch element being turned OFF after the feedback switch element has been turned OFF.

16. An electro-optical device comprising the integrated circuit device as defined in claim 1.

17. An electronic instrument comprising the electro-optical device as defined in claim 16.
